(19) United States
(12) Patent Application Publication
(10) Pub. No.: US 2023/0236415 A1
(43) Pub. Date: Jul. 27, 2023

(54) IMAGE GENERATION AND DELIVERY IN A DISPLAY SYSTEM UTILIZING A TWO-DIMENSIONAL (2D) FIELD OF VIEW EXPANDER

(71) Applicant: Meta Platforms Technologies, LLC, Menlo Park, CA (US)

(72) Inventors: Yang YANG, Redmond, WA (US); Wai Sze Tiffany LAM, Lynnwood, WA (US); Dominic MEISER, Bothell, WA (US); Wanli CHI, Sammamish, WA (US)

(73) Assignee: Meta Platforms Technologies, LLC, Menlo Park, CA (US)

(21) Appl. No.: 17/585,350

(22) Filed: Jan. 26, 2022

(51) Int. Cl. G02B 27/00; G02B 27/01; F21V 8/00; G02B 5/18

(52) U.S. Cl. CPC G02B 27/0081; G02B 27/0172; G02B 6/005; G02B 5/1842; G02B 2027/0178

(57) ABSTRACT

According to examples, a system for image generation and delivery in a display device using two-dimensional (2D) field of view (FOV) expander is described. In addition, the system may include a first lens a first lens assembly having a first projector to propagate first display light associated with a first image and a first two-dimensional (2D) expander including a first waveguide for propagating the first display light to a first eye of a user and a second lens assembly having a second projector to propagate second display light associated with a second image and a second two-dimensional (2D) expander having a second waveguide for propagating the second display light to a first eye of a user.

### TECHNICAL FIELD

This patent application relates generally to a display system with enhanced image delivery, and more specifically, to systems and methods for image generation and delivery in a display device using two-dimensional (2D) field of view (FOV) expander.

### BACKGROUND

With recent advances in technology, prevalence and proliferation of content creation and delivery has increased greatly in recent years. In particular, interactive content such as virtual reality (VR) content, augmented reality (AR) content, mixed reality (MR) content, and content within and associated with a real and/or virtual environment (e.g., a “metaverse”) has become appealing to consumers.

To facilitate delivery of this and other related content, service providers have endeavored to provide various forms wearable display systems. One such example may be a head-mounted device (HMD), such as wearable headset, wearable eyewear, or eyeglasses.

It may be appreciated that to meet consumer demand and expectation, various aspects of image delivery from these wearable display systems may be eligible for improvement and/or enhancement. One example may include providing an expansive field of view (FOV). However, in many instances, providing an expansive field of view (FOV) may require an increase in the number of electronic or optical components, which in turn may adversely increase in the size, weight, and overall bulk of such systems.

### BRIEF DESCRIPTION OF DRAWINGS

Features of the present disclosure are illustrated by way of example and not limited in the following figures, in which like numerals indicate like elements. One skilled in the art will readily recognize from the following that alternative examples of the structures and methods illustrated in the figures can be employed without departing from the principles described herein.

FIG. 1 illustrates a block diagram of an artificial reality system environment including a near-eye display, according to an example.

FIG. 2 illustrates a perspective view of a near-eye display in the form of a head-mounted display (HMD) device, according to an example.

FIG. 3 is a perspective view of a near-eye display in the form of a pair of glasses, according to an example.

FIG. 4 illustrates a schematic diagram of an optical system in a near-eye display system, according to an example.

FIG. 5 illustrates a diagram of a waveguide, according to an example.

FIG. 6 illustrates a diagram of a waveguide including an arrangement of volume Bragg gratings (VBGs), according to an example

FIGS. 7A-7B illustrate diagrams of waveguide configurations including an arrangement of volume Bragg gratings (VBGs), according to examples.

FIG. 8 illustrates a diagram of a back-mounted arrangement for a display system in a shape of eyeglasses, according to an example.

FIGS. 9A-9B illustrate various diagrams and graphical representations associated with a waveguide configuration, according to an example.

FIGS. 10A-10C illustrate a plurality of graphical representations associated with one or more volume Bragg gratings (VBGs) in a waveguide configuration, according to an example.

FIGS. 11A-11B illustrate a plurality of graphical representations associated with effects of crosstalk in one or more volume Bragg gratings (VBGs) of a waveguide configuration, according to an example.

FIG. 12 illustrates a graphical representation of responses associated with a plurality of sets of one or more volume Bragg gratings (VBGs) of a waveguide configuration.

FIG. 13 illustrates a diagram of a volume Bragg grating (VBG) layer having an adiabatic slant variation, according to an example.

FIGS. 14A-14C illustrate various diagrams and graphical representations associated with aspects of a plurality of sets of one or more volume Bragg gratings (VBGs) of a waveguide configuration implementing adiabatic slant variation, according to an example.

FIG. 15A-15E illustrates various diagrams and graphical representations associated with aspects of a grating having a multi-layer lamination design, according to an example.

FIGS. 16A-16C illustrate various diagrams and graphical representations associated with a multi-layer lamination design for a grating in a waveguide configuration, according to an example.

FIG. 17 illustrates various graphical representations of efficiency responses for one or more volume Bragg gratings (VBGs) of a waveguide configuration, according to an example.

FIGS. 18A-18C illustrate various diagrams and graphical representations associated with one or more volume Bragg gratings (VBGs) for a waveguide configuration, according to an example.

FIG. 19 illustrates a diagram of one or more volume Bragg gratings (VBGs) of a waveguide configuration, according to an example.

FIG. 20 illustrates various graphical representations associated with one or more input volume Bragg gratings (VBGs) of a waveguide configuration in association with a two-dimensional (2D) expander, according to an example.

FIG. 21 illustrates various graphical representations associated with component level optimization(s) of one or more input volume Bragg gratings (VBGs) of a waveguide configuration in association with a two-dimensional (2D) expander.

FIG. 22 illustrates various graphical representations associated with one or more input volume Bragg gratings (VBGs) of a waveguide configuration in association with a two-dimensional (2D) expander, according to an example.

FIG. 23 illustrates various graphical representations associated with component level optimization of one or more input volume Bragg gratings (VBGs) of a waveguide configuration in association with a two-dimensional (2D) expander, according to an example.

FIG. 24 illustrates various graphical representations associated with one or more input volume Bragg gratings (VBGs) of a waveguide configuration in association with a two-dimensional (2D) expander, according to an example.

FIGS. 25A-25C illustrate various diagrams of delta n (i.e., spatial variation or spatial multiplexing) distributions that may be implemented with regard to one or more volume Bragg gratings (VBGs) associated with a color, according to examples.

FIG. 26 illustrates a diagram of a waveguide configuration associated with a two-dimensional (2D) expander, according to an example.

FIG. 27 illustrates various graphical representations associated with one or more volume Bragg gratings (VBGs) of a waveguide configuration utilized in a two-dimensional (2D) expander, according to an example.

FIG. 28 illustrates various graphical representations associated with one or more volume Bragg gratings (VBGs) of a waveguide configuration utilized in a two-dimensional (2D) expander, according to an example.

FIG. 29 illustrates a block method for method for manufacturing a two-dimensional (2D) expander for a display system having a wearable eyewear arrangement, according to an example.

### DETAILED DESCRIPTION

For simplicity and illustrative purposes, the present application is described by referring mainly to examples thereof. In the following description, numerous specific details are set forth in order to provide a thorough understanding of the present application. It will be readily apparent, however, that the present application may be practiced without limitation to these specific details. In other instances, some methods and structures readily understood by one of ordinary skill in the art have not been described in detail so as not to unnecessarily obscure the present application. As used herein, the terms “a” and “an” are intended to denote at least one of a particular element, the term “includes” means includes but not limited to, the term “including” means including but not limited to, and the term “based on” means based at least in part on.

The systems and methods described herein may provide a display system (e.g., AR-based head-mounted device (HMD) or eyewear) including at least a two-dimensional (2D) expander for receiving light from at least one projector of the display system to provide an expanded field of view (FOV) and improved eyebox efficiency. In some examples, and as discussed further below, a two-dimensional (2D) expander, as described herein, may be a component associated with the device system to receive and propagate displayed light that may be associated with an image to be displayed, and may enable implementation of a larger field of view (FOV) for viewing the image to be displayed.

In some examples, the systems and methods described herein may be associated with a volume Bragg grating (VBG)-based waveguide display device. In particular, in some examples, a two-dimensional (2D) expander as described may be implemented via use of, among other things, one or more volume Bragg gratings (VBGs) as described. As used herein, a volume Bragg grating (VBG) may refer to a substantially and/or completely transparent optical device or component that may exhibit a periodic variation of refractive index (e.g., using a volume Bragg grating (VBG)). As discussed further in the examples below, an arrangement of one or more volume Bragg gratings (VBGs) may be provided with or integrated within a waveguide configuration of a display system. As used herein, a waveguide (or “waveguide configuration”) may refer to any optical structure that propagates a variety of signals (e.g., optical signals, electromagnetic waves, sound waves, etc.) in one or more directions. Employing principles of physics, information contained in such signals, may be directed using any number of waveguides or similar components.

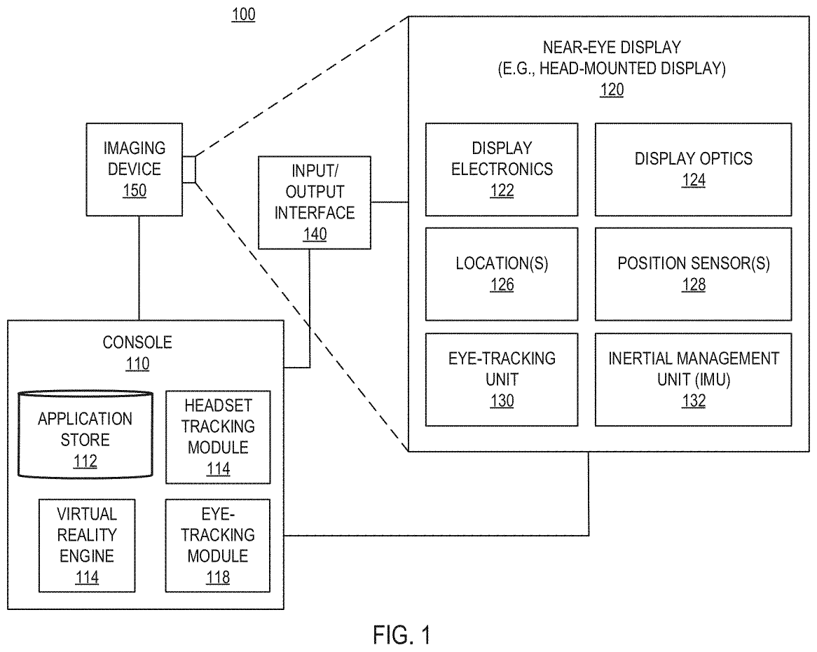

FIG. 1 illustrates a block diagram of an artificial reality system environment 100 including a near-eye display, according to an example. As used herein, a “near-eye display” may refer to a device (e.g., an optical device) that may be in close proximity to a user's eye. As used herein, “artificial reality” may refer to aspects of, among other things, a “metaverse” or an environment of real and virtual elements, and may include use of technologies associated with virtual reality (VR), augmented reality (AR), and/or mixed reality (MR). As used herein a “user” may refer to a user or wearer of a “near-eye display.”

As shown in FIG. 1, the artificial reality system environment 100 may include a near-eye display 120, an optional external imaging device 150, and an optional input/output interface 140, each of which may be coupled to a console 110. The console 110 may be optional in some instances as the functions of the console 110 may be integrated into the near-eye display 120. In some examples, the near-eye display 120 may be a head-mounted display (HMD) that presents content to a user.

In some instances, for a near-eye display system, it may generally be desirable to expand an eyebox, reduce display haze, improve image quality (e.g., resolution and contrast), reduce physical size, increase power efficiency, and increase or expand field of view (FOV). As used herein, “field of view” (FOV) may refer to an angular range of an image as seen by a user, which is typically measured in degrees as observed by one eye (for a monocular HMD) or both eyes (for binocular HMDs). Also, as used herein, an “eyebox” may be a two-dimensional box that may be positioned in front of the user's eye from which a displayed image from an image source may be viewed.

In some examples, in a near-eye display system, light from a surrounding environment may traverse a “see-through” region of a waveguide display (e.g., a transparent substrate) to reach a user's eyes. For example, in a near-eye display system, light of projected images may be coupled into a transparent substrate of a waveguide, propagate within the waveguide, and be coupled or directed out of the waveguide at one or more locations to replicate exit pupils and expand the eyebox.

In some examples, the near-eye display 120 may include one or more rigid bodies, which may be rigidly or non-rigidly coupled to each other. In some examples, a rigid coupling between rigid bodies may cause the coupled rigid bodies to act as a single rigid entity, while in other examples, a non-rigid coupling between rigid bodies may allow the rigid bodies to move relative to each other.

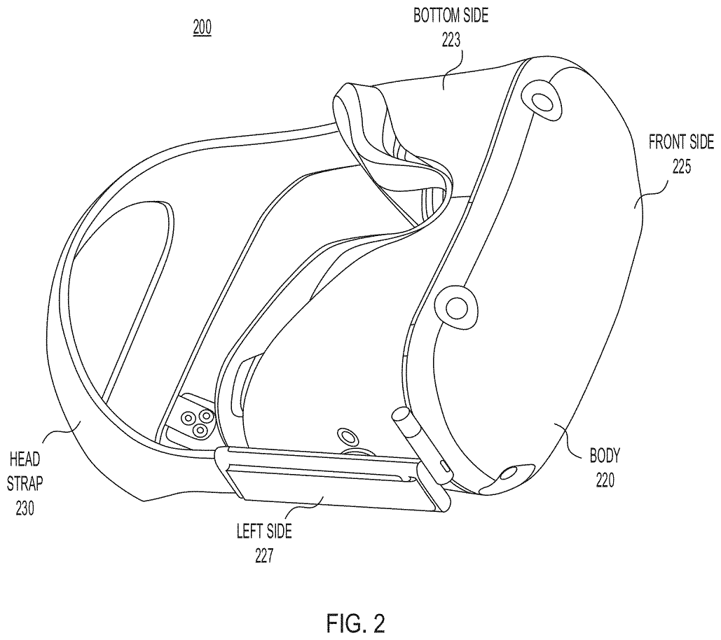

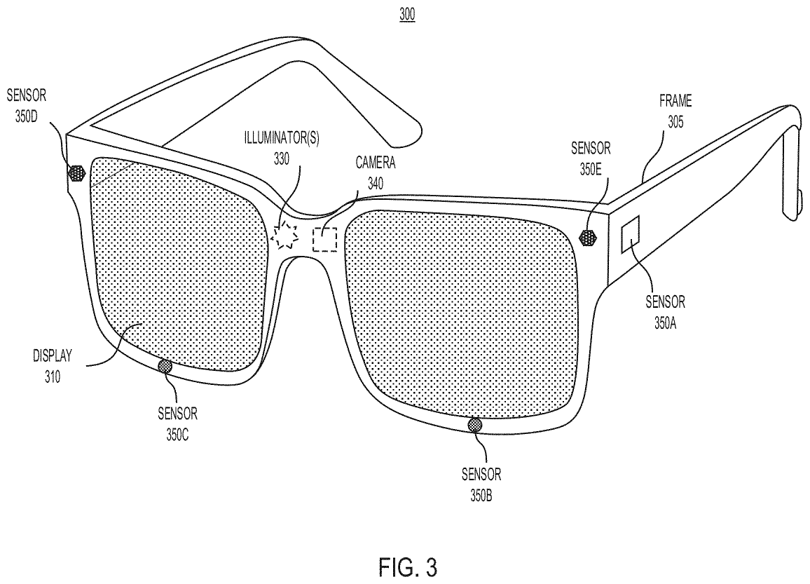

In some examples, the near-eye display 120 may be implemented in any suitable form-factor, including a HMD, a pair of glasses, or other similar wearable eyewear or device. Examples of the near-eye display 120 are further described below with respect to FIGS. 2 and 3. Additionally, in some examples, the functionality described herein may be used in a HMD or headset that may combine images of an environment external to the near-eye display 120 and artificial reality content (e.g., computer-generated images). Therefore, in some examples, the near-eye display 120 may augment images of a physical, real-world environment external to the near-eye display 120 with generated and/or overlaid digital content (e.g., images, video, sound, etc.) to present an augmented reality to a user.

In some examples, the near-eye display 120 may include any number of display electronics 122, display optics 124, and an eye-tracking unit 130. In some examples, the near-eye display 120 may also include one or more locators 126, one or more position sensors 128, and an inertial measurement unit (IMU) 132. In some examples, the near-eye display 120 may omit any of the eye-tracking unit 130, the one or more locators 126, the one or more position sensors 128, and the inertial measurement unit (IMU) 132, or may include additional elements.

In some examples, the display electronics 122 may display or facilitate the display of images to the user according to data received from, for example, the optional console 110. In some examples, the display electronics 122 may include one or more display panels. In some examples, the display electronics 122 may include any number of pixels to emit light of a predominant color such as red, green, blue, white, or yellow. In some examples, the display electronics 122 may display a three-dimensional (3D) image, e.g., using stereoscopic effects produced by two-dimensional panels, to create a subjective perception of image depth.

In some examples, the display optics 124 may display image content optically (e.g., using optical waveguides and/or couplers) or magnify image light received from the display electronics 122, correct optical errors associated with the image light, and/or present the corrected image light to a user of the near-eye display 120. In some examples, the display optics 124 may include a single optical element or any number of combinations of various optical elements as well as mechanical couplings to maintain relative spacing and orientation of the optical elements in the combination. In some examples, one or more optical elements in the display optics 124 may have an optical coating, such as an anti-reflective coating, a reflective coating, a filtering coating, and/or a combination of different optical coatings.

In some examples, the display optics 124 may also be designed to correct one or more types of optical errors, such as two-dimensional optical errors, three-dimensional optical errors, or any combination thereof. Examples of two-dimensional errors may include barrel distortion, pincushion distortion, longitudinal chromatic aberration, and/or transverse chromatic aberration. Examples of three-dimensional errors may include spherical aberration, chromatic aberration field curvature, and astigmatism.

In some examples, the one or more locators 126 may be objects located in specific positions relative to one another and relative to a reference point on the near-eye display 120. In some examples, the optional console 110 may identify the one or more locators 126 in images captured by the optional external imaging device 150 to determine the artificial reality headset's position, orientation, or both. The one or more locators 126 may each be a light-emitting diode (LED), a corner cube reflector, a reflective marker, a type of light source that contrasts with an environment in which the near-eye display 120 operates, or any combination thereof.

In some examples, the external imaging device 150 may include one or more cameras, one or more video cameras, any other device capable of capturing images including the one or more locators 126, or any combination thereof. The optional external imaging device 150 may be configured to detect light emitted or reflected from the one or more locators 126 in a field of view of the optional external imaging device 150.

In some examples, the one or more position sensors 128 may generate one or more measurement signals in response to motion of the near-eye display 120. Examples of the one or more position sensors 128 may include any number of accelerometers, gyroscopes, magnetometers, and/or other motion-detecting or error-correcting sensors, or any combination thereof.

In some examples, the inertial measurement unit (IMU) 132 may be an electronic device that generates fast calibration data based on measurement signals received from the one or more position sensors 128. The one or more position sensors 128 may be located external to the inertial measurement unit (IMU) 132, internal to the inertial measurement unit (IMU) 132, or any combination thereof. Based on the one or more measurement signals from the one or more position sensors 128, the inertial measurement unit (IMU) 132 may generate fast calibration data indicating an estimated position of the near-eye display 120 that may be relative to an initial position of the near-eye display 120. For example, the inertial measurement unit (IMU) 132 may integrate measurement signals received from accelerometers over time to estimate a velocity vector and integrate the velocity vector over time to determine an estimated position of a reference point on the near-eye display 120. Alternatively, the inertial measurement unit (IMU) 132 may provide the sampled measurement signals to the optional console 110, which may determine the fast calibration data.

The eye-tracking unit 130 may include one or more eye-tracking systems. As used herein, “eye tracking” may refer to determining an eye's position or relative position, including orientation, location, and/or gaze of a user's eye. In some examples, an eye-tracking system may include an imaging system that captures one or more images of an eye and may optionally include a light emitter, which may generate light that is directed to an eye such that light reflected by the eye may be captured by the imaging system. In other examples, the eye-tracking unit 130 may capture reflected radio waves emitted by a miniature radar unit. These data associated with the eye may be used to determine or predict eye position, orientation, movement, location, and/or gaze.

In some examples, the near-eye display 120 may use the orientation of the eye to introduce depth cues (e.g., blur image outside of the user's main line of sight), collect heuristics on the user interaction in the virtual reality (VR) media (e.g., time spent on any particular subject, object, or frame as a function of exposed stimuli), some other functions that are based in part on the orientation of at least one of the user's eyes, or any combination thereof. In some examples, because the orientation may be determined for both eyes of the user, the eye-tracking unit 130 may be able to determine where the user is looking or predict any user patterns, etc.

In some examples, the input/output interface 140 may be a device that allows a user to send action requests to the optional console 110. As used herein, an “action request” may be a request to perform a particular action. For example, an action request may be to start or to end an application or to perform a particular action within the application. The input/output interface 140 may include one or more input devices. Example input devices may include a keyboard, a mouse, a game controller, a glove, a button, a touch screen, or any other suitable device for receiving action requests and communicating the received action requests to the optional console 110. In some examples, an action request received by the input/output interface 140 may be communicated to the optional console 110, which may perform an action corresponding to the requested action.

In some examples, the optional console 110 may provide content to the near-eye display 120 for presentation to the user in accordance with information received from one or more of external imaging device 150, the near-eye display 120, and the input/output interface 140. For example, in the example shown in FIG. 1, the optional console 110 may include an application store 112, a headset tracking module 114, a virtual reality engine 116, and an eye-tracking module 118. Some examples of the optional console 110 may include different or additional modules than those described in conjunction with FIG. 1. Functions further described below may be distributed among components of the optional console 110 in a different manner than is described here.

In some examples, the optional console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In some examples, the modules of the optional console 110 described in conjunction with FIG. 1 may be encoded as instructions in the non-transitory computer-readable storage medium that, when executed by the processor, cause the processor to perform the functions further described below. It should be appreciated that the optional console 110 may or may not be needed or the optional console 110 may be integrated with or separate from the near-eye display 120.

In some examples, the application store 112 may store one or more applications for execution by the optional console 110. An application may include a group of instructions that, when executed by a processor, generates content for presentation to the user. Examples of the applications may include gaming applications, conferencing applications, video playback application, or other suitable applications.

In some examples, the headset tracking module 114 may track movements of the near-eye display 120 using slow calibration information from the external imaging device 150. For example, the headset tracking module 114 may determine positions of a reference point of the near-eye display 120 using observed locators from the slow calibration information and a model of the near-eye display 120. Additionally, in some examples, the headset tracking module 114 may use portions of the fast calibration information, the slow calibration information, or any combination thereof, to predict a future location of the near-eye display 120. In some examples, the headset tracking module 114 may provide the estimated or predicted future position of the near-eye display 120 to the virtual reality engine 116.

In some examples, the virtual reality engine 116 may execute applications within the artificial reality system environment 100 and receive position information of the near-eye display 120, acceleration information of the near-eye display 120, velocity information of the near-eye display 120, predicted future positions of the near-eye display 120, or any combination thereof from the headset tracking module 114. In some examples, the virtual reality engine 116 may also receive estimated eye position and orientation information from the eye-tracking module 118. Based on the received information, the virtual reality engine 116 may determine content to provide to the near-eye display 120 for presentation to the user.

In some examples, the eye-tracking module 118 may receive eye-tracking data from the eye-tracking unit 130 and determine the position of the user's eye based on the eye tracking data. In some examples, the position of the eye may include an eye's orientation, location, or both relative to the near-eye display 120 or any element thereof. So, in these examples, because the eye's axes of rotation change as a function of the eye's location in its socket, determining the eye's location in its socket may allow the eye-tracking module 118 to more accurately determine the eye's orientation.

In some examples, a location of a projector of a display system may be adjusted to enable any number of design modifications. For example, in some instances, a projector may be located in front of a viewer's eye (i.e., “front-mounted” placement). In a front-mounted placement, in some examples, a projector of a display system may be located away from a user's eyes (i.e., “world-side”). In some examples, a head-mounted display (HMD) device may utilize a front-mounted placement to propagate light towards a user's eye(s) to project an image.

FIG. 2 illustrates a perspective view of a near-eye display in the form of a head-mounted display (HMD) device 200, according to an example. In some examples, the HMD device 200 may be a part of a virtual reality (VR) system, an augmented reality (AR) system, a mixed reality (MR) system, another system that uses displays or wearables, or any combination thereof. In some examples, the HMD device 200 may include a body 220 and a head strap 230. FIG. 2 shows a bottom side 223, a front side 225, and a left side 227 of the body 220 in the perspective view. In some examples, the head strap 230 may have an adjustable or extendible length. In particular, in some examples, there may be a sufficient space between the body 220 and the head strap 230 of the HMD device 200 for allowing a user to mount the HMD device 200 onto the user's head. In some examples, the HMD device 200 may include additional, fewer, and/or different components.

In some examples, the HMD device 200 may present, to a user, media or other digital content including virtual and/or augmented views of a physical, real-world environment with computer-generated elements. Examples of the media or digital content presented by the HMD device 200 may include images (e.g., two-dimensional (2D) or three-dimensional (3D) images), videos (e.g., 2D or 3D videos), audio, or any combination thereof. In some examples, the images and videos may be presented to each eye of a user by one or more display assemblies (not shown in FIG. 2) enclosed in the body 220 of the HMD device 200.

In some examples, the HMD device 200 may include various sensors (not shown), such as depth sensors, motion sensors, position sensors, and/or eye tracking sensors. Some of these sensors may use any number of structured or unstructured light patterns for sensing purposes. In some examples, the HMD device 200 may include an input/output interface 140 for communicating with a console 110, as described with respect to FIG. 1. In some examples, the HMD device 200 may include a virtual reality engine (not shown), but similar to the virtual reality engine 116 described with respect to FIG. 1, that may execute applications within the HMD device 200 and receive depth information, position information, acceleration information, velocity information, predicted future positions, or any combination thereof of the HMD device 200 from the various sensors.

In some examples, the information received by the virtual reality engine 116 may be used for producing a signal (e.g., display instructions) to the one or more display assemblies. In some examples, the HMD device 200 may include locators (not shown), but similar to the virtual locators 126 described in FIG. 1, which may be located in fixed positions on the body 220 of the HMD device 200 relative to one another and relative to a reference point. Each of the locators may emit light that is detectable by an external imaging device. This may be useful for the purposes of head tracking or other movement/orientation. It should be appreciated that other elements or components may also be used in addition or in lieu of such locators.

It should be appreciated that in some examples, a projector mounted in a display system may be placed near and/or closer to a user's eye (i.e., “eye-side”). In some examples, and as discussed herein, a projector for a display system shaped liked eyeglasses may be mounted or positioned in a temple arm (i.e., a top far corner of a lens side) of the eyeglasses. It should be appreciated that, in some instances, utilizing a back-mounted projector placement may help to reduce size or bulkiness of any required housing required for a display system, which may also result in a significant improvement in user experience for a user.

FIG. 3 is a perspective view of a near-eye display 300 in the form of a pair of glasses (or other similar eyewear), according to an example. In some examples, the near-eye display 300 may be a specific implementation of near-eye display 120 of FIG. 1, and may be configured to operate as a virtual reality display, an augmented reality display, and/or a mixed reality display.

In some examples, the near-eye display 300 may include a frame 305 and a display 310. In some examples, the display 310 may be configured to present media or other content to a user. In some examples, the display 310 may include display electronics and/or display optics, similar to components described with respect to FIGS. 1-2. For example, as described above with respect to the near-eye display 120 of FIG. 1, the display 310 may include a liquid crystal display (LCD) display panel, a light-emitting diode (LED) display panel, or an optical display panel (e.g., a waveguide display assembly). In some examples, the display 310 may also include any number of optical components, such as waveguides, gratings, lenses, mirrors, etc.

In some examples, the near-eye display 300 may further include various sensors 350a, 350b, 350c, 350d, and 350e on or within a frame 305. In some examples, the various sensors 350a-350e may include any number of depth sensors, motion sensors, position sensors, inertial sensors, and/or ambient light sensors, as shown. In some examples, the various sensors 350a-350e may include any number of image sensors configured to generate image data representing different fields of views in one or more different directions. In some examples, the various sensors 350a-350e may be used as input devices to control or influence the displayed content of the near-eye display 300, and/or to provide an interactive virtual reality (VR), augmented reality (AR), and/or mixed reality (MR) experience to a user of the near-eye display 300. In some examples, the various sensors 350a-350e may also be used for stereoscopic imaging or other similar application.

In some examples, the near-eye display 300 may further include one or more illuminators 330 to project light into a physical environment. The projected light may be associated with different frequency bands (e.g., visible light, infra-red light, ultra-violet light, etc.), and may serve various purposes. In some examples, the one or more illuminators 330 may be used as locators, such as the one or more locators 126 described above with respect to FIGS. 1-2.

In some examples, the near-eye display 300 may also include a camera 340 or other image capture unit. The camera 340, for instance, may capture images of the physical environment in the field of view. In some instances, the captured images may be processed, for example, by a virtual reality engine (e.g., the virtual reality engine 116 of FIG. 1) to add virtual objects to the captured images or modify physical objects in the captured images, and the processed images may be displayed to the user by the display 310 for augmented reality (AR) and/or mixed reality (MR) applications.

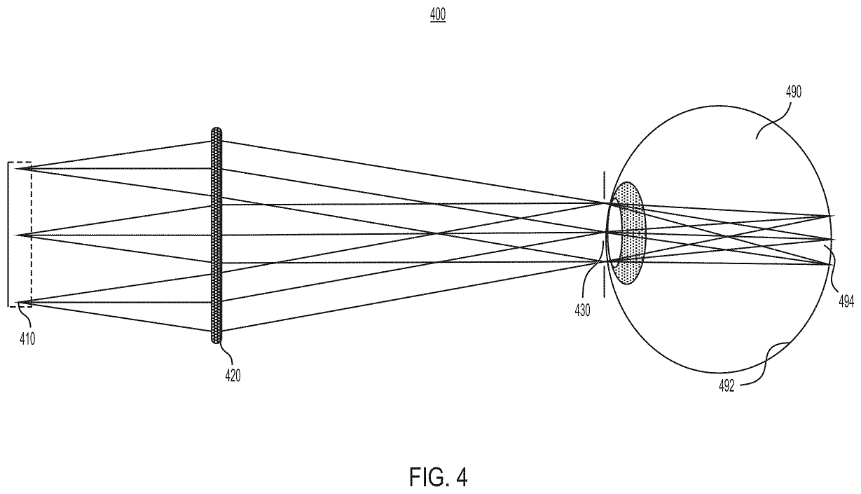

FIG. 4 illustrates a schematic diagram of an optical system 400 in a near-eye display system, according to an example. In some examples, the optical system 400 may include an image source 410 and any number of projector optics 420 (which may include waveguides having gratings as discussed herein). In the example shown in FIG. 4, the image source 410 may be positioned in front of the projector optics 420 and may project light toward the projector optics 420. In some examples, the image source 410 may be located outside of the field of view (FOV) of a user's eye 490. In this case, the projector optics 420 may include one or more reflectors, refractors, or directional couplers that may deflect light from the image source 410 that is outside of the field of view (FOV) of the user's eye 490 to make the image source 410 appear to be in front of the user's eye 490. Light from an area (e.g., a pixel or a light emitting device) on the image source 410 may be collimated and directed to an exit pupil 430 by the projector optics 420. In some examples, the exit pupil 430 may have a diameter of three (3) millimeters (mm). Thus, objects at different spatial locations on the image source 410 may appear to be objects far away from the user's eye 490 in different viewing angles (i.e., fields of view (FOV)). The collimated light from different viewing angles may then be focused by the lens of the user's eye 490 onto different locations on retina 492 of the user's eye 490. For example, at least some portions of the light may be focused on a fovea 494 on the retina 492. Collimated light rays from an area on the image source 410 and incident on the user's eye 490 from a same direction may be focused onto a same location on the retina 492. As such, a single image of the image source 410 may be formed on the retina 492.

In some instances, a user experience of using an artificial reality system may depend on several characteristics of the optical system, including field of view (FOV), image quality (e.g., angular resolution), size of the eyebox (to accommodate for eye and head movements), and brightness of the light (or contrast) within the eyebox. Also, in some examples, to create a fully immersive visual environment, a large field of view (FOV) may be desirable because a large field of view (FOV) (e.g., greater than about 60°) may provide a sense of “being in” an image, rather than merely viewing the image. In some instances, smaller fields of view may also preclude some important visual information. For example, a head-mounted display (HMD) system with a small field of view (FOV) may use a gesture interface, but users may not readily see their hands in the small field of view (FOV) to be sure that they are using the correct motions or movements. On the other hand, wider fields of view may require larger displays or optical systems, which may influence the size, weight, cost, and/or comfort of the head-mounted display (HMD) itself.

In some examples, a waveguide may be utilized to couple light into and/or out of a display system. In particular, in some examples and as described further below, light of projected images may be coupled into or out of the waveguide using any number of reflective or diffractive optical elements, such as gratings. For example, as described further below, one or more volume Bragg gratings (VBGs) may be utilized in a waveguide-based, back-mounted display system (e.g., a pair of glasses or similar eyewear).

In some examples, one or more volume Bragg gratings (VBGs) (or two portions of a same grating) may be used to diffract display light from a projector to a user's eye. Furthermore, in some examples, the one or more volume Bragg gratings (VBGs) may also help compensate for any dispersion of display light caused by each other to reduce the overall dispersion in a waveguide-based display system.

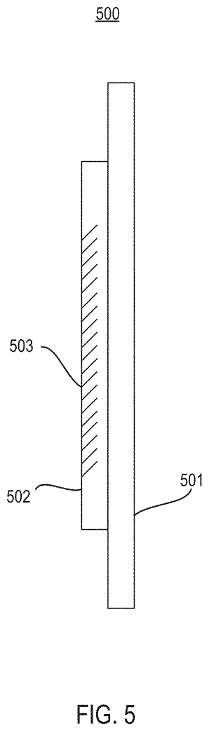

FIG. 5 illustrates a diagram of a waveguide configuration 500, according to an example. In some examples, the waveguide configuration 500 may include a plurality of layers, such as at least one substrate 501 and at least one photopolymer layer 502. In some examples, the substrate 501 may be a comprised of a polymer or glass material. In some examples, the photopolymer layer 502 may be transparent or “see-through,” and may include any number of photosensitive materials (e.g., a photo-thermo-refractive glass) or other similar material.

In some examples, the at least one substrate 501 and the at least one photopolymer layer 502 may be optically bonded (e.g., glued on top of each other) to form the waveguide configuration 500. In some examples, the substrate 501 may have a thickness of anywhere between around 0.1-1.0 millimeters (mm) or other thickness range. In some examples, the photopolymer layer 502 may be a film layer having a thickness of anywhere between about 50-500 micrometers (μm) or other range.

In some examples, one or more volume Bragg gratings (VBGs) may be provided in (or exposed into) the photopolymer layer 502. That is, in some examples, the one or more volume Bragg gratings may be exposed by generating an interference pattern 503 into the photopolymer layer 502. In some examples, the interference pattern 503 may be generated by superimposing two lasers to create a spatial modulation that may generate the interference pattern 503 in and/or throughout the photopolymer layer 502. In some examples, the interference pattern 503 may be a sinusoidal pattern. Also, in some examples, the interference pattern 503 may be made permanent via a chemical, optical, mechanical, or other similar process.

By exposing the interference pattern 503 into the photopolymer layer 502, for example, the refractive index of the photopolymer layer 502 may be altered and a volume Bragg grating may be provided in the photopolymer layer 502. Indeed, in some examples, a plurality of volume Bragg gratings or one or more sets of volume Bragg gratings may be exposed in the photopolymer layer 502. It should be appreciated that this technique may be referred to as “multiplexing.” It should also be appreciated that other various techniques to provide a volume Bragg grating (VBG) in or on the photopolymer layer 502 may also be provided.

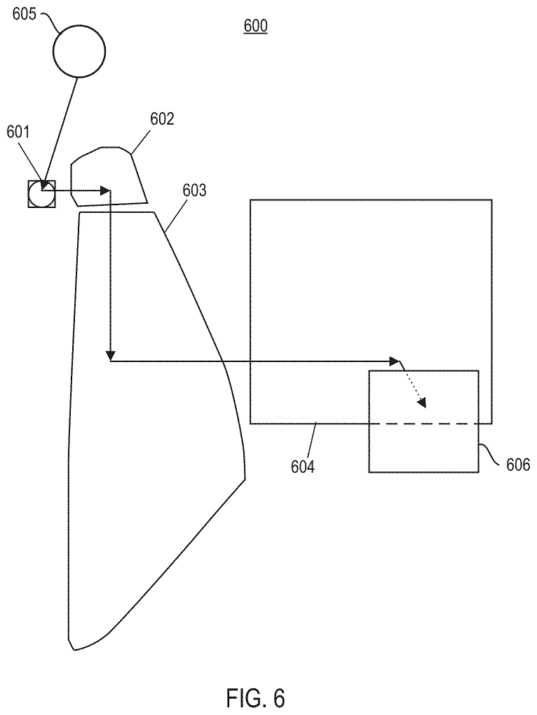

FIG. 6 illustrates a diagram of a waveguide configuration 600 including an arrangement of volume Bragg gratings (VBGs), according to an example. In some examples, the waveguide configuration 600 may be used a display system, similar to the near-eye display system 300 of FIG. 3. The waveguide configuration 600, as shown, may include an input volume Bragg grating (VBG) 601 (“input grating” or “IG,” “inbound grating,” or “in-coupling grating”), a first middle volume Bragg grating (VBG) 602 (“first middle grating”, “M1,” or “MG1”), a second middle volume Bragg grating (VBG) 603 (“second middle grating”, “M2,” or “MG2”), and an output volume Bragg grating (VBG) 604 (“output grating” or “OG,” “outbound grating,” or “out-coupling grating”). It should be appreciated that, as used herein and in some instances, the terms “grating” and “gratings” may be used interchangeably, in that “grating” may include an arrangement of a plurality of gratings or grating structures.

In some examples, a projector 605 of the display system may transmit display light (indicated by an arrow) to the arrangement of volume Bragg gratings (VBGs) 601-604, starting with the input volume Bragg grating (VBG) 601 (which receives the display light from the projector), then through the first middle volume Bragg grating (VBG) 602 and the second middle volume Bragg grating (VBG) 603, and then to the output volume Bragg grating (VBG) 604 which propagates the display light to an eyebox or a user's eye 606.

As discussed above, the waveguide configuration 600 may include any number of volume Bragg gratings (VBGs) that may be exposed into a “see-through” photopolymer material, such as glass or plastic. In some examples and as discussed above, one or more of the arrangement of volume Bragg gratings (VBGs) 601-604 may be patterned (e.g., using sinusoidal patterning) into and/or on a surface of the photopolymer material. In this way, the entire waveguide configuration 600 may be relatively transparent so that a user may see through to the other side. At the same time, the waveguide configuration 600, with its various arrangements of volume Bragg gratings (VBGs) 601-604 may (among other things) receive the propagated display light from the projector and exit the propagated display light in front of a user's eyes for viewing. In this way any number of augmented reality (AR) and/or mixed reality (MR) environments may be provided to and experienced by the user. In addition, in some examples, the arrangement of volume Bragg gratings (VBGs) 601-604 may be implemented to “expand” (i.e., horizontally and/or vertically) a region in space to be viewed so that a user may view a displayed image regardless of where a pupil of a user's eye may be. As such, in some examples, by expanding this viewing region, the arrangement of volume Bragg gratings (VBGs) 601-604 may ensure that a user may move their eye in various directions and still view the displayed image.

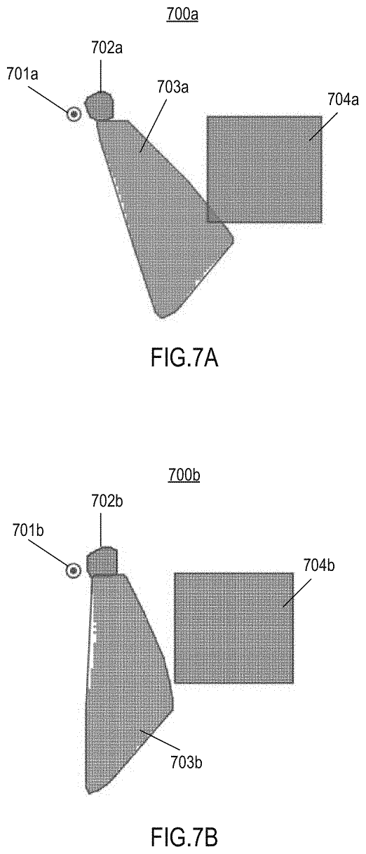

FIGS. 7A-7B illustrate diagrams of waveguide configurations 700a-700b including an arrangement of volume Bragg gratings (VBGs), according to examples. For example, waveguide configuration 700a may illustrate one arrangement of volume Bragg gratings (VBGs) 701a-704a and waveguide configuration 700b may illustrate another arrangement of volume Bragg gratings (VBGs) 701b-704b. It should be appreciated that these waveguide configurations 700a-700b, or other configurations, may be included in a waveguide-based display system, as described herein.

In some examples, as discussed further below, the arrangement of volume Bragg gratings (VBGs) 701a-704a may be combined (i.e., “stacked” or “tiled”) with the arrangement of volume Bragg gratings (VBGs) 701b-704b. In particular, the arrangement of volume Bragg gratings (VBGs) 701a-704a (i.e., directed to a left field of view (FOV)) and the arrangement of volume Bragg gratings (VBGs) 701b-704b (i.e., directed to a right field of view (FOV)) may be implemented (i.e., “tiled”) to cooperatively expand a viewing eyebox and support of a larger field of view (FOV).

In some examples, the arrangement of volume Bragg gratings (VBGs) 701a-704a may include an input volume Bragg grating (VBG) 701a, a first middle volume Bragg grating (VBG) 702a, a second middle volume Bragg grating (VBG) 703a, and an output volume Bragg grating (VBG) 704a. So, in some examples, a projector (not shown) may propagate display light to the input volume Bragg grating (VBG) 701a, through the first middle volume Bragg grating (VBG) 702a and the second middle volume Bragg grating (VBG) 703a, and for exiting through the output volume Bragg grating (VBG) 704a. More specifically, in some examples, a first expansion of a field of view (FOV) (in a first dimension) may be accomplished via the first middle volume Bragg grating (VBG) 702a and the second middle volume Bragg grating (VBG) 703a, while a second expansion of the field of view (FOV) (in a second dimension) may be accomplished via the output volume Bragg grating (VBG) 704a.

Also, as shown in FIG. 7B, in some examples, a projector (not shown) may propagate display light to input volume Bragg grating (VBG) 701b, a first middle volume Bragg grating (VBG) 702b and a second middle volume Bragg grating (VBG) 703b and output volume Bragg gratings (VBG) 704b. Again, in some examples, the projector may propagate display light to the input volume Bragg grating (VBG) 701b, through the first middle volume Bragg grating (VBG) 702b and the second middle volume Bragg grating (VBG) 703b and for exiting through the output volume Bragg grating (VBG) 704b. In particular, in some examples, a first expansion of a field of view (FOV) (in a first dimension) may be accomplished via the first middle volume Bragg grating (VBG) 702b and the second middle volume Bragg grating (VBG) 703b, while a second expansion of the field of view (FOV) (in a second dimension) may be accomplished via the output volume Bragg grating (VBG) 704b.

As discussed above, in some examples, a “back-mounted” projector may be utilized to provide a significant reduction of size (i.e., bulk) of a display system. For example, in some instances, a display system in a shape of eyewear (e.g., eyeglasses) may implement one or more projectors located “eye-side” to provide a significant improvement in user experience.

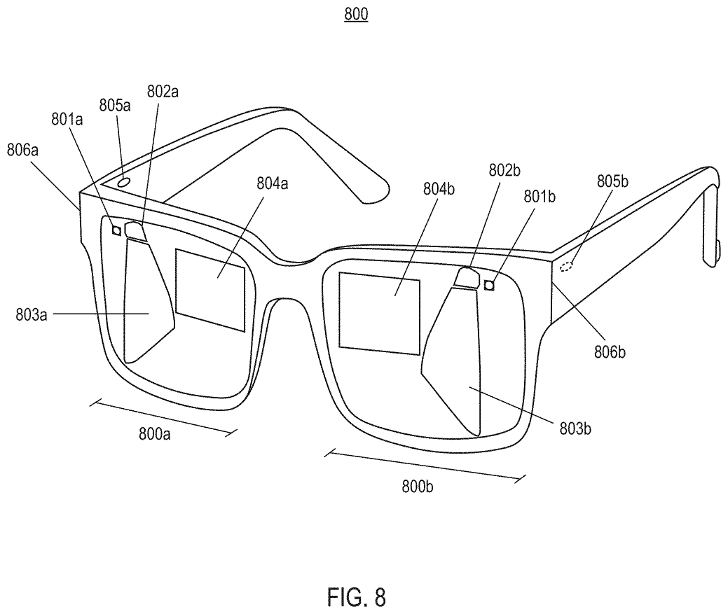

FIG. 8 illustrates a diagram of a back-mounted arrangement for a display system 800 in a shape of eyeglasses, according to an example. In some examples, the display system 800 may include a right waveguide configuration 800a and a left waveguide configuration 800b. Each of the right waveguide configuration 800a and the left waveguide configuration 800b shown here may be similar to the waveguide configuration 600 of FIG. 6. For example, each of the waveguide configurations, as shown in FIG. 8, may use similar types of volume Bragg gratings (VBGs) arrangements to those shown in FIG. 6. For instance, the right waveguide configuration 800a may include an input volume Bragg grating (VBG) 801a, a first middle volume Bragg grating (VBG) 802a, a second middle volume Bragg grating (VBG) 803a, and an output volume Bragg grating (VBG) 804a, and the left waveguide configuration 800b may include an input volume Bragg grating (VBG) 801b, a first middle volume Bragg grating (VBG) 802b, a second middle volume Bragg grating (VBG) 803b, and an output volume Bragg grating (VBG) 804b.

With regard to the right waveguide configuration 800a, in some examples, a right projector 805a may be mounted at an interior side of a right temple arm 806a of the display system 800. In some examples, the right projector 805a may propagate light to and/or through the input volume Bragg grating (VBG) 801a to the first middle volume Bragg grating (VBG) 802a and the second middle volume Bragg grating (VBG) 803a and then to the output volume Bragg grating (VBG) 804a.

With regard to the left waveguide configuration 800b, in some examples, a left projector 805b may be mounted at an interior side of a left temple arm 806b of the display system 800. In some examples, the left projector 805b may propagate light to and/or through the input volume Bragg grating (VBG) 801b to the first middle volume Bragg grating (VBG) 802b and the second middle volume Bragg grating (VBG) 803b and then to the output volume Bragg grating (VBG) 804b.

Accordingly, in some examples, the right waveguide configuration 800a and the left waveguide configuration 800b may present a first display image and a second display image, respectively, to be viewed by a user's respective eye, when wearing the eyewear, to generate a simultaneous, “binocular” viewing. That is, in some examples, the first image projected by the right projector 805a and the second image projected by the left projector 805b may be uniformly and symmetrically “merged” to create a binocular visual effect for a user. It may be appreciated that such an arrangement may provide various benefits to a user.

In some examples, a waveguide configuration including one or more of volume Bragg gratings (VBGs) may implement pitch multiplexing. As used herein, “pitch multiplexing” may include use of one or more gratings (e.g., volume Bragg gratings (VBGs)) that may be arranged to provide varying wavelength periods (i.e., “pitches”). In some instances, a “pitch” may also be referred to herein as a “surface pitch” or “surface pitch angle.”

So, in some examples, the one or more volume Bragg gratings (VBGs) may each be layered with respect to each other, and may each provide varying pitches. In some instances, this layering may be referred to as “multiplexing,” wherein the one or more volume Bragg gratings (VBGs) may be “multiplexed” together. Also, in some examples, the (multiplexed) one or more volume Bragg gratings (VBGs) may provide a uniform (i.e., identical), or near uniform (e.g., nearly identical) grating direction across the one or more volume Bragg gratings (VBGs).

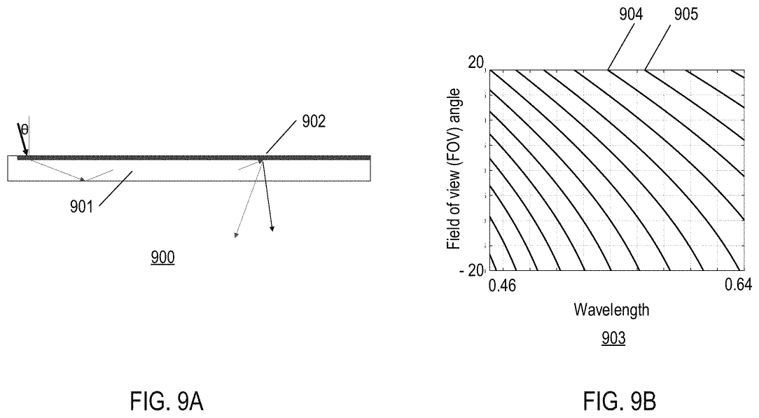

FIGS. 9A-9B illustrate various diagrams and graphical representations associated with a waveguide configuration 900, according to an example. In some examples, the waveguide configuration 900 may be implemented in a one-dimensional (1D) or two-dimensional field of view (FOV) expander (i.e., also “expander”) as described herein. In some examples and as shown in FIG. 9A, the waveguide configuration 900 may include a photopolymer layer 901 and one or more volume Bragg gratings (VBGs) 902. In some examples, the one or more volume Bragg gratings (VBGs) 902 may be exposed by generating an interference pattern onto a film layer (not shown) adjoining into the photopolymer layer 901. Also, in some examples, the one or more volume Bragg gratings (VBGs) 902 may implement a uniform grating direction, and may implement a plurality of (i.e., varying) wavelength pitches.

In FIG. 9B, a graphical representation 903 illustrating a relationship between a range of wavelength pitches (i.e., x-axis) and a field of view (FOV) (i.e., y-axis) supported by the waveguide configuration 900 is shown. In some examples, lines 904, 905 may each represent a range of wavelengths implemented by a particular volume Bragg grating (VBG) included in the one or more volume Bragg gratings (VBGs) 902. In some examples, the lines 904, 905 may also be referred to as “diffraction curves.” In addition, in some examples, the lines 904, 905 may each represent a Bragg condition associated with a particular grating thickness and angular selectivity (i.e., varying pitch) for the particular volume Bragg grating (VBG) of the one or more volume Bragg gratings (VBGs) 902.

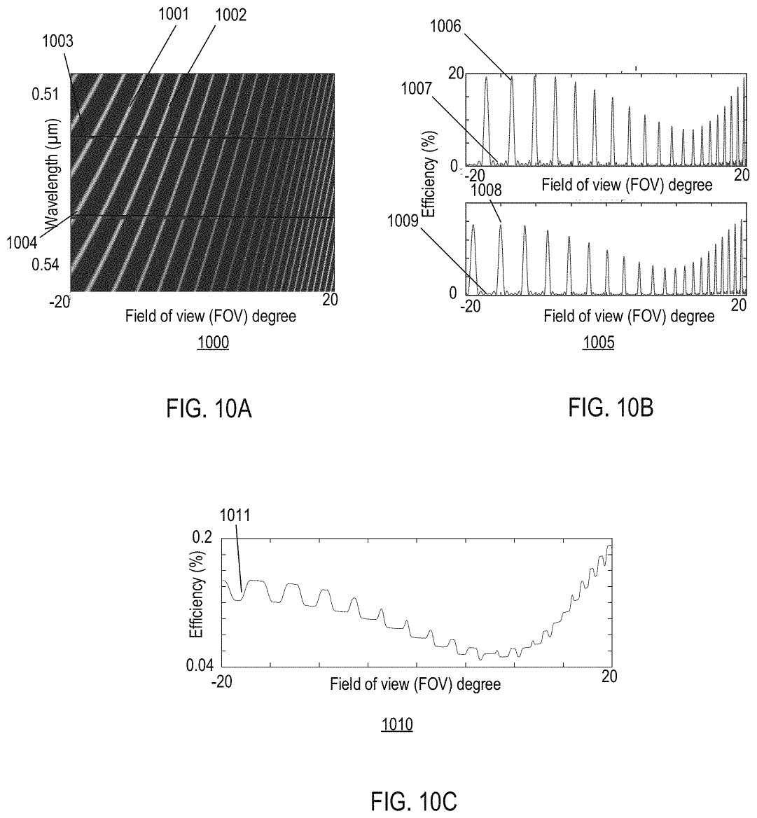

FIGS. 10A-10C illustrate a plurality of graphical representations 1000, 1005, 1010 associated with one or more volume Bragg gratings (VBGs) in a waveguide configuration (e.g., the waveguide configuration 900), according to an example. In FIG. 10A, a graphical representation illustrating a relationship between a field of view (FOV) coverage (i.e., x-axis) and a range of wavelength pitches (i.e., y-axis) is shown. In FIG. 10A, each line 1001, 1002 may represent a grating response for a volume Bragg grating (VBG) in the one or more volume Bragg gratings (VBGs). In some examples, a first cross-section 1003 may be associated with a first, single wavelength (e.g., 0.5183 micrometers (μm)) in the range of wavelength pitches, and a second cross-section 1004 may be associated with a second, single wavelength (e.g., 0.5303 micrometers (μm)) in the range of wavelength pitches.

FIG. 10B illustrates graphical representations 1005 of wavelength characteristics associated with the first cross-section 1003 and the second cross-section 1004 illustrated in FIG. 10A. In FIG. 10B, the graphical representations 1005 illustrate a relationship between a field of view (FOV) coverage (i.e., x-axis) and a range of efficiencies (i.e., y-axis) is shown. In some examples, for each wavelength associated with the first cross-section 1003 and the second cross-section 1004, gratings included in the one or more volume Bragg gratings (VBGs) of the waveguide configuration may display peak efficiencies 1006, 1008, and minimum efficiencies 1007, 1009. In some instances, the minimum efficiencies may reach zero efficiency. As a result, in some instances wherein a zero or near-zero efficiency may be present, an entire field of view (FOV) may not be covered.

In some examples, to counteract such minimum efficiencies, a wavelength band may be provided. In some examples, the wavelength band may be implemented via a broadband source. FIG. 10C illustrates a graphical representation 1010 of wavelength characteristics associated with one or more volume Bragg gratings (VBGs) of a waveguide configuration when subjected to a wavelength band. In FIG. 10C, graphical representations a relationship between a field of view (FOV) coverage (i.e., x-axis) and a range of efficiencies (i.e., y-axis) is shown.

As shown in FIG. 10C, in some examples, utilizing a wavelength band may reduce a number of minimum or zero efficiency instances, and may instead provide a more generally uniform efficiency response for the one or more volume Bragg gratings (VBGs). As a result, in some examples, an entire field of view (FOV) may be covered (more) continuously and without a drop to zero or near-zero efficiency). Nevertheless, as shown in FIG. 10C, it should be also appreciated that although the field of view (FOV) may be covered more continuously via use of the wavelength band, variations (i.e., peaks and drops) 1011 in efficiency may still persist.

In some examples, such variations may be further mitigated by increasing a number of gratings included in the one or more gratings in the waveguide configuration. In particular, in some examples, variations in efficiency responses may be mitigated by providing additional (e.g., densely-packed) gratings in the one or more volume Bragg gratings (VBGs).

However, in some examples, it should be appreciated that while inclusion of additional gratings may enable coverage of a wider dynamic range of field of view (FOV), it may also result in each additional grating covering a comparatively smaller portion of a dynamic wavelength range as well. As a result, in some instances, it may be necessary to balance a number of additional gratings to be added with an expected performance for each grating in the one or more volume Bragg gratings (VBGs).

In some examples, it should be appreciated that increasing a number of gratings may increase a likelihood of crosstalk. As used herein, “crosstalk” may include any instance where a signal transmitted on one element of a transmission system may create an undesired effect in another element of the transmission system. So, in some examples, by increasing the number of gratings in one or more volume Bragg gratings (VBGs) of a waveguide configuration, each grating may produce an undesired effect in one or more adjacent gratings. In some examples, in instances where crosstalk may be present, a light signal may “in-couple” in a first grating at a particular (i.e., correct) angle and may “out-couple” from a second grating at a different (i.e., incorrect) angle.

In some examples, to overcome issues associated with crosstalk, one or more volume Bragg gratings (VBSs) of a waveguide configuration may employ side-lobe reduction. As used herein, “side-lobe reduction” may include any design and/or technique that may ensure that each grating in a plurality of gratings may be associated with a particular color and a particular (associated) angle. So, in some examples, side-lobe reduction may provide a limiting of a light signal's ingress and egress through a particular grating. More specifically, in some examples, side-lobe reduction may ensure that for a light signal propagating at any angle, the light signal may only be “coupled-in” in a particular manner and may only be “coupled-out” in a particular manner as well.

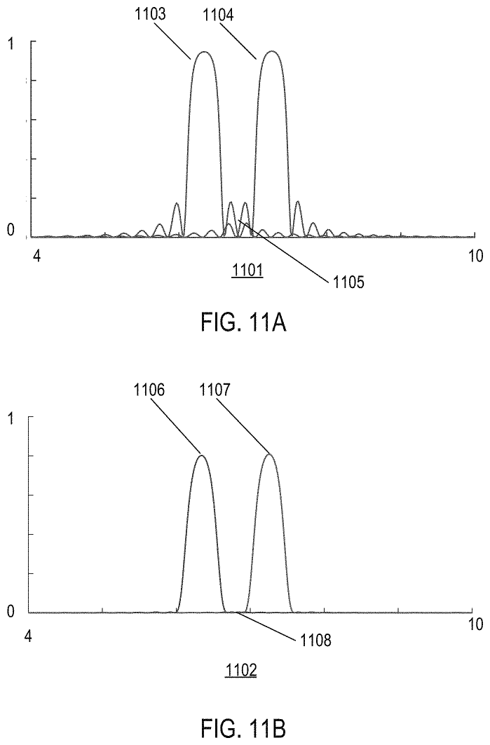

FIGS. 11A-11B illustrate a plurality of graphical representations 1101-1102 associated with effects of crosstalk in one or more volume Bragg gratings (VBGs) of a waveguide configuration, according to an example. In FIGS. 11A-11B, graphical representations 1101, 1102 illustrate a relationship between an angle (i.e., in degrees) associated with the one or more volume Bragg gratings (VBGs) of the waveguide configuration (i.e., x-axis) and a range of associated efficiencies (i.e., y-axis.)

So, in some examples and as shown in FIG. 11A, where crosstalk mitigation (e.g., via side-lobe reduction) may not be employed, a first signal response from a first grating 1103 may be shown to interfere with a first signal response from a second grating 1104, as evidenced by an indication of crosstalk 1105. On the other hand, in an instance where crosstalk mitigation (e.g., via side-lobe reduction) may be utilized to limit or eliminate crosstalk, a light signal may ideally “in-couple” in a first grating and may “out-couple” in the first grating at a desired angle. So, as shown in FIG. 11B, for a second signal response from the first grating 1106 and a second signal response from the second grating 1107 may lead to minimal to none crosstalk, as evidenced by an indication of minimal to none crosstalk 1108.

In some examples, a “varying slant” design may be implemented to address various issues associated with implementation of pitch multiplexing. As used herein, a “varying slant” implementation in one or more volume Bragg gratings (VBGs) may include a variation in a slant angle for each volume Bragg grating (VBG) for the one or more volume Bragg gratings (VBGs) from a first (i.e., initial) angle to a second (i.e., final) angle. In some examples, implementation of a varying slant or “slant variation” may enable support of a larger field of view (FOV) by a waveguide configuration that may, for example, be included in a one-dimensional (1D) or two-dimensional (2D) field of view expander of a display system as described herein.

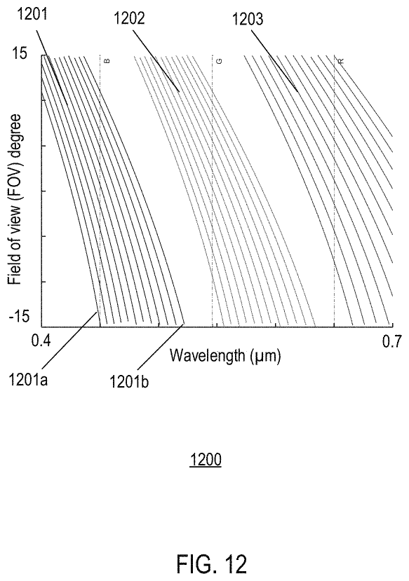

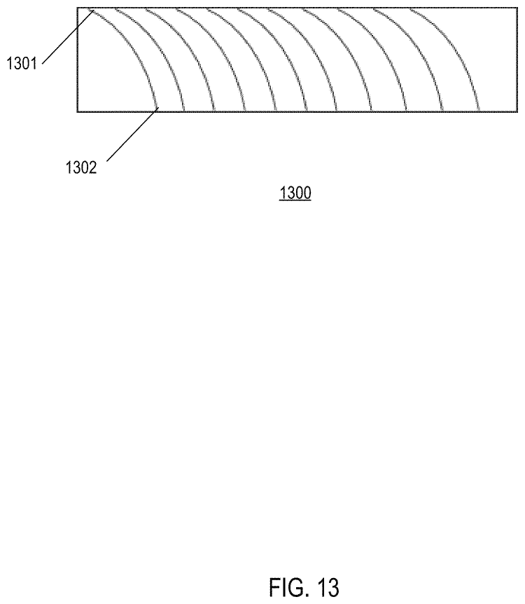

FIG. 12 illustrates a graphical representation 1200 of responses associated with a plurality of sets of one or more volume Bragg gratings (VBGs) of a waveguide configuration, according to an example. FIG. 12 provides a relationship between a range of wavelength pitches (x-axis) and for a field of view (FOV) coverage (y-axis) supported by the plurality of sets of one or more volume Bragg gratings (VBGs) of the waveguide configuration. In the example provided in FIG. 12, a base refractive index (n) of 1.6 may be implemented. It should be appreciated that an entire range of base refractive indexes (n) may be implemented (e.g., from 1.5 to 2.0), according to examples provided herein. Furthermore, in some examples, various materials (e.g., photopolymer, holographic polymer dispersed liquid crystal (HPDLC), liquid crystal polymer, etc.) may be implemented as well, according to examples provided herein.

In some examples, the responses shown in FIG. 12 may include responses for a first set of one or more volume Bragg gratings (VBGs) 1201, a second set of one or more volume Bragg gratings (VBGs) 1202 of the waveguide configuration, and a third set of one or more volume Bragg gratings (VBGs) 1203. In some examples, the first set of one or more volume Bragg gratings (VBGs) 1201 may be associated with a wavelength range for blue, the second set of one or more volume Bragg gratings (VBGs) 1202 may be associated with a wavelength range for green, and the third set of one or more volume Bragg gratings (VBGs) 1203 may be associated with a wavelength range for red. In some instances, the combination of blue, green and red may be referred to as the “color band.”

In some examples, to implement a slant variation, each grating of the first set of one or more volume Bragg gratings (VBGs) 1201, the second set of one or more volume Bragg gratings (VBGs) 1202, and the third set of one or more volume Bragg gratings (VBGs) 1203 may be associated with a particular slant angle. That is, in some examples, the particular slant angle of each one of the sets of volume Bragg gratings (VBGs) may be unique from the slant angles of the sets of other volume Bragg gratings (VBGs). Furthermore, in some examples, each line 1201a, 1201b may represent a particular slant angle associated with each grating in a set of one or more volume Bragg gratings (VBGs). Also, in some examples, to implement a color band, each of the first set of one or more volume Bragg gratings (VBGs) (i.e., blue), the second set of one or more volume Bragg gratings (VBGs) (i.e., green), and the third set of one or more volume Bragg gratings (VBGs) (i.e., red) may be associated with a (respective) pitch) as well.

In some examples, instead of a base refractive index of 1.6, a base refractive index (n) of 1.8 may be implemented. In these examples, the plurality of sets of one or more volume Bragg gratings (VBGs) of FIG. 12 may support a large (r) field of view (FOV). However, in some examples, the plurality of sets of one or more volume Bragg gratings (VBG) may also display crosstalk issues. Also, in other examples, a base refractive index (n) of 1.9 may be implemented. In these examples, the plurality of sets of one or more volume Bragg gratings (VBGs) may also support a large (r) field of view (FOV). Moreover, in some examples, the plurality of sets of one or more volume Bragg gratings (VBGs) may also display better crosstalk control as well.

In some examples, an adiabatic slant design may be utilized to achieve a varying slant design for one or more volume Bragg gratings (VBGs) in a waveguide configuration. As used herein, an “adiabatic” slant design may refer to a design configuration wherein a first slant angle associated with a volume Bragg grating may smoothly transition to a second slant angle across a grating thickness. Also, as used herein, in some examples, a slant angle may smoothly transition when the slant angle may transition continuously and without interruption.

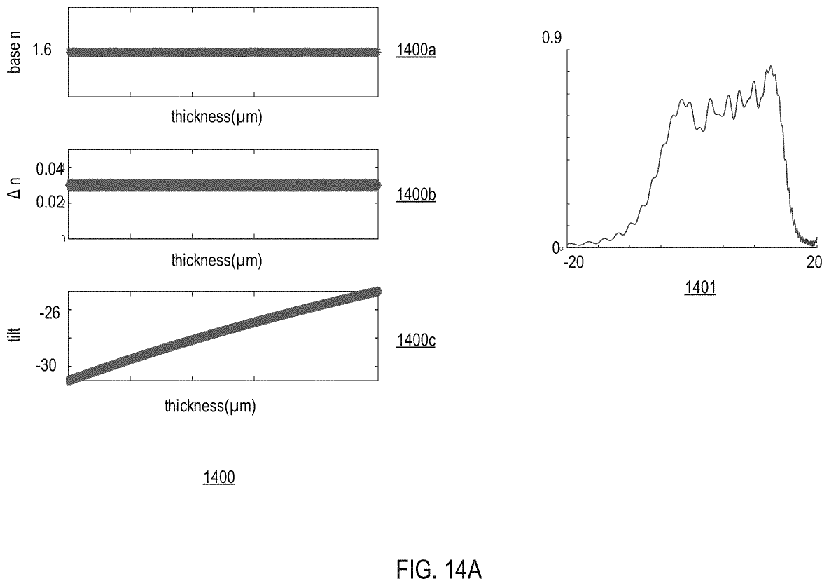

FIG. 13 illustrates a diagram of a grating layer 1300 having an adiabatic slant variation, according to an example. In some examples, the grating layer 1300 may be a grating layer in a volume Bragg grating (VBG) to be included in a volume Bragg grating (VBG) arrangement of a waveguide configuration. In some examples, to implement adiabatic slant variation, while a pitch of the grating 1300 may be maintained across a thickness of a film of the grating 1300, a slant angle may change continuously from a first angle associated with top 1301 to a second angle associated with a bottom 1302 across a grating thickness. As discussed below, in some examples, adiabatic slant variation may enable increased efficiencies and improved crosstalk control, while still accommodating angle and wavelength selectivity. In some examples, a grating layer having an adiabatic slant variation may provide an “ideal” transition from a first angle to a second angle, and may mitigate any possibility of a drop in efficiency (e.g., due to a phase offset) as light may pass through the grating. Moreover, in some examples where each of a first, second, and third set of one or more volume Bragg gratings (VBGs) may be associated with each color (e.g., blue, green, red) in a color band, adiabatic slant variation may be implemented with respect particular slant angles and particular angular variations as well.

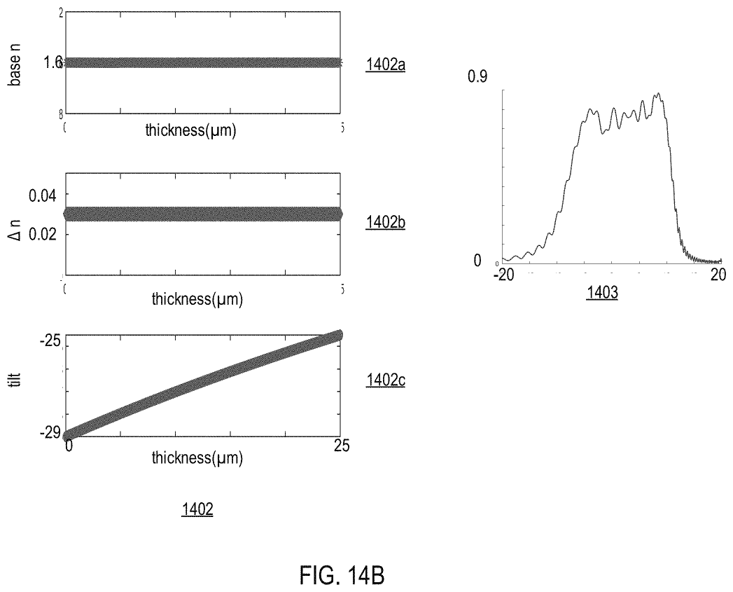

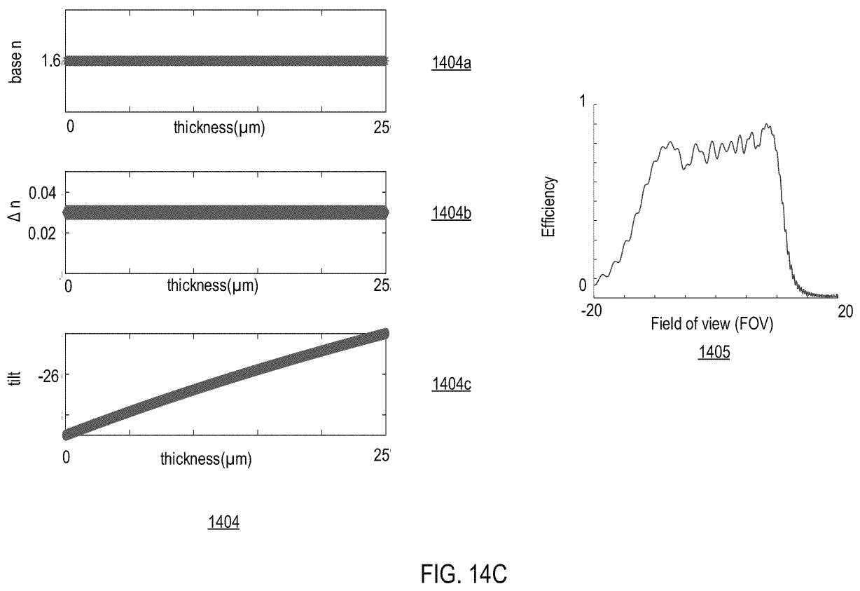

FIGS. 14A-14C illustrate various diagrams and graphical representations 1400-1405 associated with aspects of a plurality of sets of one or more volume Bragg gratings (VBGs) of a waveguide configuration implementing adiabatic slant variation, according to an example. In some examples, each of a first set of one or more volume Bragg gratings (VBGs), a second set of one or more volume Bragg gratings (VBGs), and a third set of one or more volume Bragg gratings (VBGs) may adiabatically transition (i.e., vary) from top to bottom. Also, in some examples, each of the first set of one or more volume Bragg gratings (VBGs), the second set of one or more volume Bragg gratings (VBGs), and the third set of one or more volume Bragg gratings (VBGs) may implement a different pitch.

In some examples, FIG. 14A may be associated with the first set of one or more volume Bragg gratings (VBGs). Also, in some examples, the first set of one or more volume Bragg gratings (VBGs) may be associated with blue of a color band. So, in some examples and as shown in FIG. 14A, for a thickness of approximately 0.1 to 25 micrometers (μm), the first set of one or more volume Bragg gratings (VBGs) may have base n (i.e., refractive index) of 1.6 (as indicated in 1400a), may have delta n (i.e., spatial distribution or spatial multiplexing) of approximately 0.03 (as indicated in 1400b), and may have tilt (angle) of −32 to −24 degrees (as indicated in 1400c). In some examples, the first set of one or more volume Bragg gratings (VBGs) may exhibit an efficiency response as indicated in the graphical representation 1401, where the x-axis may indicate field of view (FOV) coverage and the y-axis may indicate efficiency.

In some examples, FIG. 14B may be associated with the second set of one or more volume Bragg gratings (VBGs). Also, in some examples, the second set of one or more volume Bragg gratings (VBGs) may be associated with green of a color band. In some examples and as shown in FIG. 14B, for a thickness of approximately 0.1 to 25 micrometers (μm), the second set of one or more volume Bragg gratings (VBGs) may have base n (i.e., refractive index) of 1.6 (as indicated in 1402a), may have delta n (i.e., spatial distribution or spatial multiplexing) of approximately 0.03 (as indicated in 1402b), and may have tilt (angle) of −29 to −24 degrees (as indicated in 1402c). In some examples, the second set of one or more volume Bragg gratings (VBGs) may exhibit an efficiency response as indicated in the graphical representation 1403, where the x-axis may indicate a field of view (FOV) coverage and the y-axis may indicate efficiency.

In some examples, FIG. 14C may be associated with the third set of one or more volume Bragg gratings (VBGs). In some examples, the third set of one or more volume Bragg gratings (VBGs) may be associated with a red of a color band. In some examples and as shown in FIG. 14C, for a thickness of approximately 0.1 to 25 micrometers (μm), the third set of one or more volume Bragg gratings (VBGs) may have base n (i.e., refractive index) of 1.6 (as indicated in 1404a), may have delta n (i.e., spatial distribution or spatial multiplexing) of approximately 0.03 (as indicated in 1404b), and may have tilt (angle) of −30 to −24 degrees (as indicated in 1404c). In some examples, the third set of one or more volume Bragg gratings (VBGs) may exhibit an efficiency response as indicated in the graphical representation 1405, where the x-axis may indicate a field of view (FOV) coverage and the y-axis may indicate efficiency.

In some examples, a multi-layer lamination design may be utilized to achieve a varying slant design for one or more volume Bragg gratings (VBGs) in a waveguide configuration. In particular, in some examples, to vary from a first slant angle to a second slant angle over a volume Bragg grating (VBG) thickness, a plurality of discrete film layers may be utilized to implement a plurality of discrete slant angles. In some examples, by laminating the plurality of discrete film layers, a “transition” (i.e., varying) from the first slant angle to the second slant angle may be achieved. It should be appreciated that, in providing this transition via a plurality of layers, any number of layers may be provided. Moreover, in some examples, providing more layers may enable a more “gradual” transition from a first angle to a second angle to more resemble that of a more “pure” adiabatic slant variation design. Furthermore, it should be appreciated that in scenarios where a “pure” adiabatic slant variation design is not available or too cumbersome to generate/design/manufacture, the multi-layer lamination design may be another approach to provide similar effects and results.

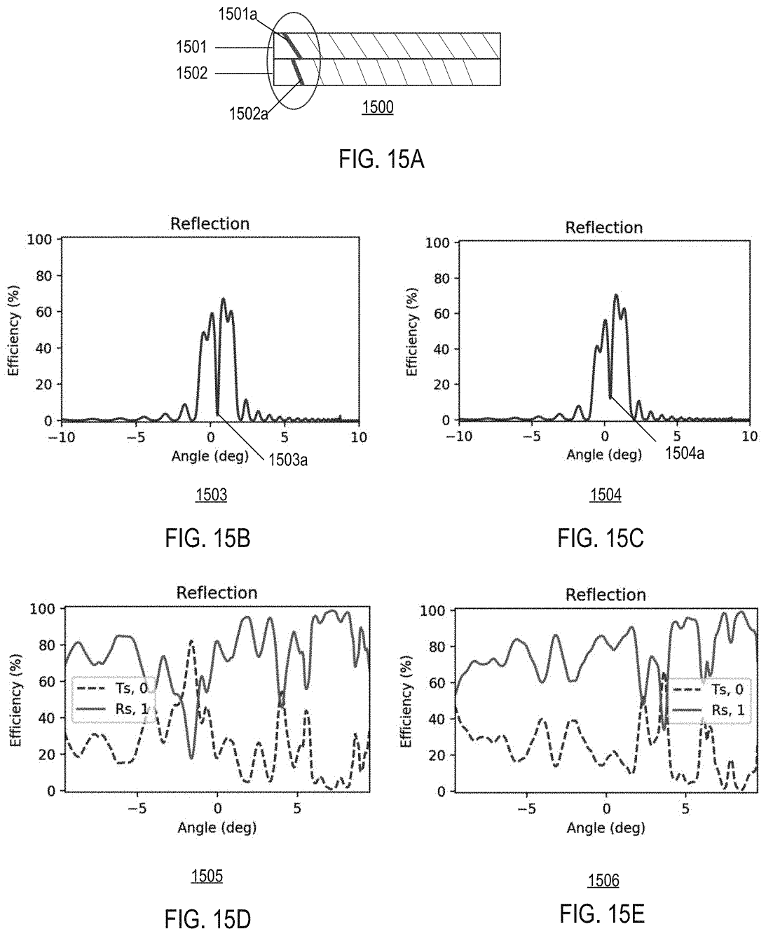

FIG. 15A-15E illustrates various diagrams 1500 and graphical representations 1503-1506 associated with aspects of a grating having a multi-layer lamination design, according to an example. In some examples, the grating 1500 may be a volume Bragg grating (VBG) included in one or more volume Bragg gratings (VBGs) of a waveguide configuration. In some examples, the one or more volume Bragg gratings (VBGs) may be included in a one-dimensional (1D) or two-dimensional (2D) field of view (FOV) expander in a display system.

In some examples, a first layer 1501 of the grating 1500 having a first slant angle 1501a and a second layer 1502 having a second slant angle 1502a. In some examples, the first slant angle 1501a and the second slant angle 1502a may be utilized to create a transition for the grating 1500.

It should be appreciated that, in some examples, implementing a multi-layer lamination design may produce a random phase offset between grating layers. That is, in some examples, in transitioning from a first slant angle (e.g., the first slant angle 1501a) to a second slant angle (e.g., the second slant angle 1502a), a discontinuity in a refractive index between a first layer (e.g., the first layer 1501) and a second layer (e.g., the second layer 1502) may produce a random (i.e., uncontrollable) phase offset that may lead to a drop in efficiency (i.e., an “artifact”).

FIGS. 15B-15D illustrate various the graphical representations 1503-1506 of responses associated with the grating 1500 with respect to a range of slant angles (x-axis) and efficiency (y-axis). So, as shown in the graphical representation 1503 of FIG. 15B and the graphical representation 1504 of FIG. 15C, in some examples, a first drop 1503a and a second drop 1504a may be associated with a transition between a first layer and a second layer of a grating employing a multi-layer lamination design. Furthermore, it may be appreciated that, in implementing a varying slant design using a multi-layer lamination design, a greater number of transitions in refractive indexes may lead to a greater number of drops in efficiency. Accordingly, as shown in the graphical representation 1505 of FIG. 15D and the graphical representation 1506 of FIG. 15E associated with a six-layer lamination design, multiple drops in efficiency due to multiple changes in refractive index may be exhibited.

In some examples, effects of a random phase offset introduced by lamination of a plurality of layers in a multi-layer lamination design may be mitigated by introduction of one or more buffer layers in between each of the plurality of layers. In particular, in some examples, while implementing a light source with a one (1) to two (2) nanometer (nm) bandwidth (i.e., spectrum), introduction of one or more buffer layers between the plurality of grating layers may render diffraction behavior(s) mitigated and/or insensitive to a random phase offset(s). In some examples, a thickness of the one or more buffer layers may be approximately one (1) to ten (10) micrometer (μm).

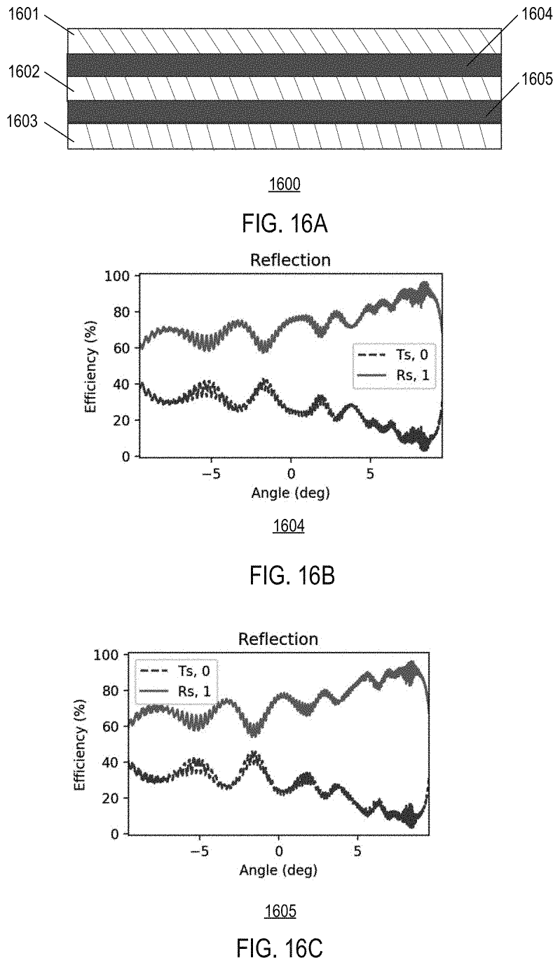

FIGS. 16A-16C illustrate various diagrams and graphical representations 1604-1605 associated with a multi-layer lamination design 1600 for a grating in a waveguide configuration, according to an example. In some examples, the multi-layer lamination design 1600 may include a first grating layer 1601, a second grating layer 1602, and a third grating layer 1603. Furthermore, in some examples, to mitigate effects of one or more random phase offsets generated by the layers 1601-1603, a first buffer layer 1604 may be introduced in between the first grating layer 1601 and the second grating layer 1602, and a second buffer layer 1605 may be introduced in between the second grating layer 1602 and the third grating layer 1603. In some examples, the first buffer layer 1604 and the second buffer layer 1605 may be comprised of material that may that have a similar (base) refractive index to a photopolymer material included in the waveguide configuration.

In some examples, introduction of the first buffer layer 1604 and the second buffer layer 1605 may minimize drops in efficiency by mitigating effects of one or more random phase offsets generated by the layers 1601-1603. In particular, as discussed above and in some examples, the first buffer layer 1604 and the second buffer layer 1605 may mitigate effects of a transition between the first grating layer 1601 and the second grating layer 1602, and also effects of a transition between the second grating layer 1602 and the third grating layer 1603. In other words, the buffer layers 1604, 1605 may, in effect, smooth out the transitions between the grating layers 1601, 1602, and 1603 to cause the slant angles to more resemble that of the more “pure” adiabatic slant variation design (as discussed above). In some examples, implementation of a multi-layer lamination design including one or more buffer layers may provide various advantages, including ease or simplicity of manufacture. Although any number of grating layers and/or buffer layers may be provided in the multi-layer lamination design, a proper balance of costs, desired application, and other factors may be considered.

FIGS. 16B-16C illustrates graphical representations 1604, 1605 of an efficiency response associated with the multi-layer lamination design 1600. In the graphical representation 1604, 1605, the efficiency responses may be with respect to a range of slant angles (i.e., x-axis) and efficiency (i.e., y axis). In some examples, the diffraction behavior of the multi-layer lamination design 1600 may be rendered substantially insensitive to random phase offsets as evidenced by the comparatively minimal dips in efficiency.

In some examples and as discussed above, one or more volume Bragg gratings (VBGs) in a waveguide configuration may be associated with a particular color (e.g., blue, green, red) of a color band. Also, in some examples and also discussed above, each of the one or more volume Bragg gratings (VBGs) may implement a particular pitch, and may employ a particular slant variation to increase a field of view (FOV). It should be appreciated that, in some instances, the one or more volume Bragg gratings (VBGs) may exhibit crosstalk in association with the plurality of colors in the color bands (i.e., with respect to each other). So, in some instances, light signals associated with a first plurality of gratings (e.g., blue) may “spill over” into a second plurality of gratings (e.g., green) and produce an undesired crosstalk effect (i.e., also referred to as “spill-over crosstalk”).

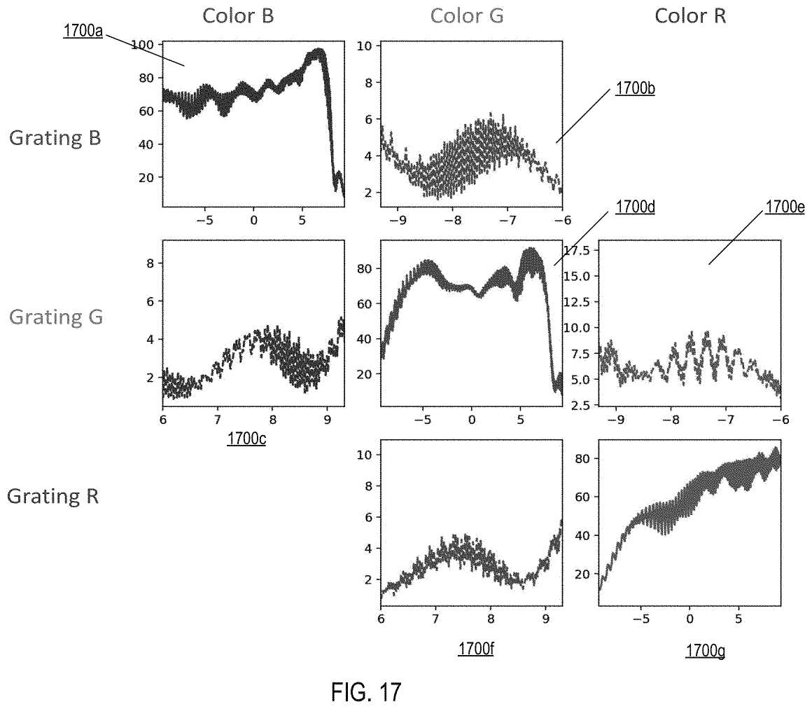

FIG. 17 illustrate various graphical representations 1700a-g of efficiency responses for one or more volume Bragg gratings (VBGs) of a waveguide configuration. In particular, the graphical representations 1700a-g illustrate various examples of efficiency responses of the one or more volume Bragg gratings across color bands. In particular, in these examples, the graphical representations 1700a-g may be associated with three sets of gratings including one or more volume Bragg gratings (VBGs) associated with blue, one or more volume Bragg gratings (VBGs) associated with green, and one or more volume Bragg gratings associated with red. In these examples, the first row 1700a-b may be associated with blue, the second row 1700c-e may be associated with green, and the third row 1700f-g may be associated with red. Furthermore, in these examples, a color response may be associated with each column, wherein the first column 1700a, 1700c may be associated with blue, the second column 1700b, 1700d, 1700f may be associated with green, and the third column 1700e, 1700g may be associated with red. In these examples, field of view (FOV) coverage may be indicated on an x-axis, while an efficiency associated with the one or more volume Bragg gratings may be indicated on the y-axis.

So, in these examples, the graphical representation 1700a may be an efficiency response for one or more volume Bragg gratings (VBGs) associated with blue, the graphical representation 1700d may be an efficiency response for one or more volume Bragg gratings (VBGs) associated with green, and the graphical representation 1700g may be an efficiency response for one or more volume Bragg gratings (VBGs) associated with red. These may be referred to as the “diagonal plots”.

Also, the graphical representation 1700b may represent a spill-over crosstalk from the one or more volume Bragg gratings (VBGs) associated with blue to create an effect in the one or more volume Bragg gratings (VBGs) associated with green. Furthermore, the graphical representation 1700c may represent a “spill over” from the one or more volume Bragg gratings (VBGs) associated with green to create an effect in the one or more volume Bragg gratings (VBGs) associated with blue. Also, the graphical representation 1700e may represent a “spill over” from the one or more volume Bragg gratings (VBGs) associated with green to create an effect in the one or more volume Bragg gratings (VBGs) associated with red. In addition, Also, the graphical representation 1700f may represent a “spill over” from the one or more volume Bragg gratings (VBGs) associated with red to create an effect in the one or more volume Bragg gratings (VBGs) associated with green. These may be referred to as the “off-diagonal” plots. In some examples, utilization of a higher base refractive index (e.g., 1.9) and thicker grating layers may mitigate these effects of crosstalk over the color band.

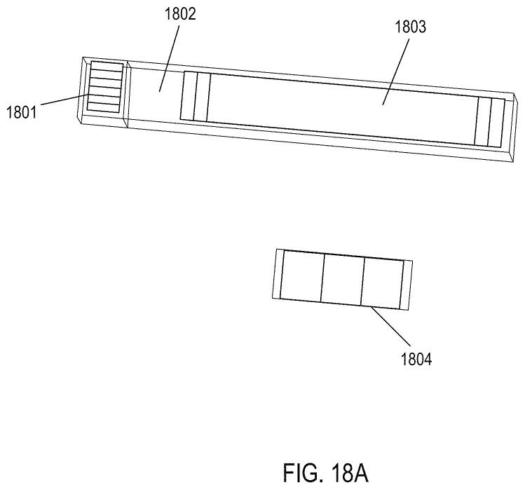

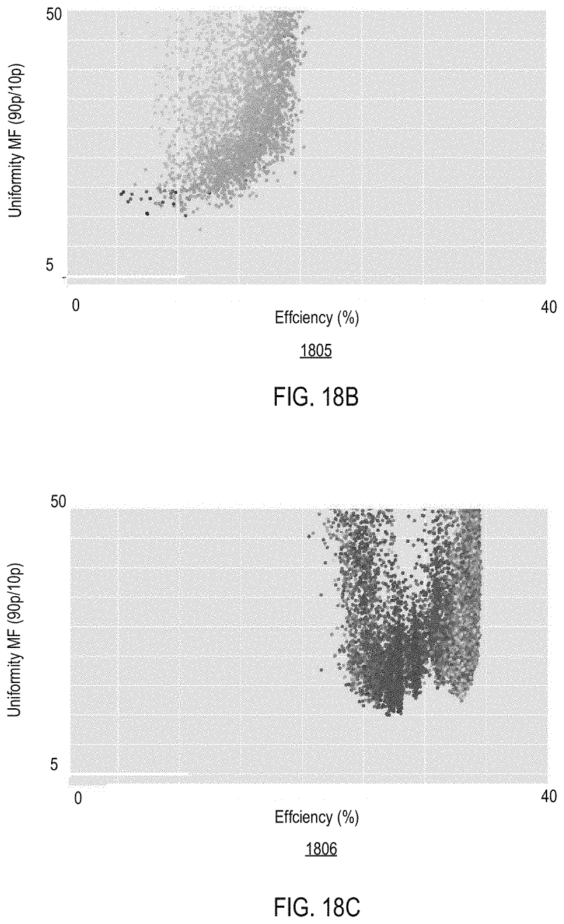

FIGS. 18A-18C illustrate various diagrams 1800 and graphical representations 1806-1807 associated with one or more volume Bragg gratings (VBGs) for a waveguide configuration, according to an example. In some examples, the plurality of gratings may be associated with a one-dimensional (1-D) expander. FIG. 18A illustrates a planar view of a set of one or more volume Bragg gratings (VBGs) 1800. In some examples, the set of one or more volume Bragg gratings (VBGs) 1800 may include one or more input volume Bragg gratings (VBGs) 1801, one or more first and second middle volume Bragg gratings (VBGs) 1802, and one or more output volume Bragg gratings (VBGs) 1803. So, in some examples, light may enter the one or more input volume Bragg gratings (VBGs) 1801, propagate through the one or more first and second middle volume Bragg gratings (VBGs)1802, and may couple out of the one or more output volume Bragg gratings (VBGs) 1803 towards eyebox 1804.

In some examples, a first set of one or more volume Bragg gratings (VBGs), a second set of one or more volume Bragg gratings (VBGs), and a third set of one or more volume Bragg gratings (VBGs) similar to the set of one or more volume Bragg gratings (VBGs) 1800 may each be implemented with respect to blue, green, and red colors of the color band. In some examples, each of the first set of one or more volume Bragg gratings (VBGs), the second set of one or more volume Bragg gratings (VBGs), and the third set of one or more volume Bragg gratings (VBGs) may implement particular slant variation, and may implement a particular pitch as well.

Also, in some examples, to overcome these issues of spill-over crosstalk discussed above, one or more volume Bragg gratings (VBGs) associated with a waveguide configuration (e.g., the set of one or more volume Bragg gratings (VBGs) 1800) may be optimized with respect to various criteria. For example, these various criteria may include eyebox efficiency, pupil uniformity (i.e., uniformity of intensity) and pupil contrast (i.e., image contrast).

To optimize according to these various criteria, various aspects of one or more volume Bragg gratings (VBGs) as described herein may be optimized. For example, a first aspect may be a slant variation associated with each grating layer of the one or more volume Bragg gratings (VBGs). In some examples, a second aspect may be a location of a slant for each grating layer of the one or more volume Bragg gratings (VBGs). Furthermore, in some examples, a third aspect may be a delta n distribution (i.e., spatial distribution or spatial multiplexing). In addition, in some examples, another aspect that may be optimized may be a grating pitch for gratings associated with each color (e.g., blue, green, red).

FIGS. 18B-18C are graphical representations 1805-1806 of responses associated with one or more volume Bragg gratings (VBGs) of a waveguide configuration for one-dimensional (1D) expander. In FIGS. 18B-18C, the x-axis may indicate an efficiency (i.e., how much light goes towards an eyebox), a left side y-axis may indicate pupil uniformity (i.e., wherein a lower result may be preferred), and the right side may indicate a color bar that may indicate pupil contrast (i.e., which may be measured by signal to noise ratio and wherein a higher result may be preferred).

In some examples, the graphical representation 1805 of FIG. 18B may illustrate responses of one or more volume Bragg gratings (VBGs) having an approximately five (5) micrometer (μm) film. In some examples, the graphical representation 1806 of FIG. 18C may illustrate responses of one or more volume Bragg gratings (VBGs) having an approximately ten (10) micrometer (μm) film. In some examples, each point indicated in the graphical representations 1806-1807 represent a functional design associated with one or more volume Bragg gratings (VBGs). In particular, each point indicated in the graphical representations 1805-1806 may implement a different combination of pitch, slant variation and delta n (i.e., spatial distribution or spatial multiplexing) associated with the pitch.

In some examples, based on responses indicated in FIGS. 18B-18C, a pitch of approximately 0.35 micrometer (μm) for one or more gratings associated with blue, a pitch of approximately 0.43 micrometer (μm) for one or more gratings associated with green, and a pitch of approximately 0.52 micrometer (μm) for one or more gratings associated with red may be selected. Moreover, in some examples and as shown by the results indicated in FIG. 18B-18C, a selection of a ten (10) micrometer (μm) film (indicated in FIG. 18B) may provide better results than a five (5) micrometer (μm) film. In particular, in some examples, results of each of eyebox efficiency, pupil uniformity (i.e., uniformity of intensity) and pupil contrast (i.e., image contrast) associated with the ten (10) micrometer (μm) film may provide equal or better results to that of the five (5) micrometer (μm) film. Accordingly, it may be appreciated that, in some examples, a thicker film (e.g., a ten (10) micrometer (μm) film) may reduce spill-over and reduce color band crosstalk.

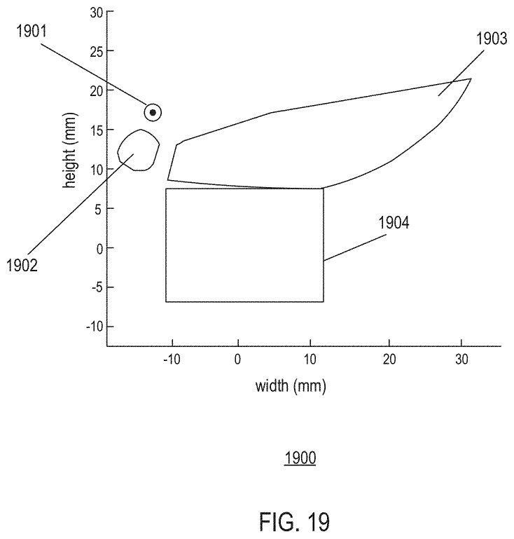

FIG. 19 illustrates a diagram of one or more volume Bragg gratings (VBGs) 1900 of a waveguide configuration, according to an example. In some examples, the one or more volume Bragg gratings (VBGs) 1900 may be employed in a two-dimensional (2D) expander, according to an example. It should be appreciated that utilization of a two-dimensional (2D) expander as described herein may provide a variety of benefits, including enabling use of a smaller projector of a display system and enabling the smaller projector to project a larger eyebox for a first dimension (e.g., height) and a second dimension (e.g., width). Also, in some examples, the waveguide configuration having the one or more volume Bragg (VBGs) 1900 may be approximately five hundred (500) micrometers (μm) thick.

In some examples, the one or more volume Bragg gratings (VBGs) 1900 may include one or more input volume Bragg gratings (VBGs) 1901, one or more first middle volume Bragg gratings (VBGs) 1902, one or more second middle volume Bragg gratings (VBGs) 1903 and one or more output volume Bragg gratings (VBGs) 1904. So, in some examples, light from a projector (not shown) may enter the one or more input volume Bragg gratings (VBGs) 1901, then propagate to the one or more first middle volume Bragg gratings (VBGs) 1902, to the one or more second middle volume Bragg gratings (VBGs) 1903, and then to the one or more output volume Bragg gratings (VBGs) towards an eyebox (not shown). In some examples, each layer of each of the volume Bragg gratings (VBGs) may be approximately five (5) micrometers (μm) thick. In other examples, each layer of each of the volume Bragg gratings (VBGs) may be approximately ten (10) micrometers (μm) thick. Accordingly, in some examples, a waveguide configuration may include between one and ten layers (including any buffer layers located in between).

In some examples, the one or more input volume Bragg gratings (VBGs) 1901 may have a height and width of approximately 5 millimeters (mm) or less. In some examples, the one or more first middle volume Bragg gratings (VBGs) 1902 may have a height and width of approximately 5 millimeters (mm). In some examples, the one or more second middle volume Bragg gratings (VBGs) 1903 may have a height of approximately 15 millimeters (mm), and width of approximately 40 millimeters (mm). In some examples, the one or more output volume Bragg gratings (VBGs) 1904 may have a height of approximately 15 millimeters (mm), and width of approximately 20 millimeters (mm).

In some examples, the one or more volume Bragg gratings (VBGs) 1900 may implement a same grating design for the one or more input volume Bragg gratings (VBGs) 1901 as the one or more output volume Bragg gratings (VBGs) 1904. In such instances, the one or more input volume Bragg gratings (VBGs) 1901 and the one or more output volume Bragg gratings (VBGs) 1904 may be referred to as a “pair” or “input/output pair.”

In some examples, providing an input/output pair may include implementing a similar or identical pitch for each color (e.g., blue, green and red) in the color band. That is, in some examples, this may include employing a set of one or more volume Bragg gratings (VBGs), similar to the one or more volume Bragg gratings (VBGs) 1900, for each color in the color band.

In some examples, the one or more input volume Bragg gratings (VBGs) 1901 may include at least one volume Bragg grating (VBG) for blue, at least one volume Bragg grating (VBG) for green, and at least one volume Bragg grating (VBG) for red. Moreover, in some examples, the one or more input volume Bragg gratings (VBGs) 1901 may share a similar or identical pitch to corresponding volume Bragg gratings (VBGs) for blue, green, and red in the one or more output volume Bragg gratings (VBGs) 1904. Also, in some examples, the one or more input volume Bragg gratings (VBGs) 1901 may utilize a similar or identical slant variation to corresponding volume Bragg gratings (VBGs) for the one or more output volume Bragg gratings (VBGs) 1904 as well.

In some examples and in a similar manner, the one or more first middle volume Bragg gratings (VBGs) 1902 may implement a same grating design as the one or more second middle volume Bragg gratings (VBGs) 1903. In such instances, the one or more first middle volume Bragg gratings (VBGs) 1902 and the one or more second middle volume Bragg gratings (VBGs) 1903 may be referred to as a “pair” or “M1/M2 pair.”

In some examples, this may include implementing a similar or identical pitch for each color (e.g., blue, green and red) in the color band. So, similar to the examples above, gratings associated with each color for the first middle volume Bragg gratings (VBGs) 1902 may share a similar or identical pitch to corresponding volume Bragg gratings (VBGs) for blue, green, and red in the one or more second middle volume Bragg gratings (VBGs) 1903. Also, in some examples, this may include utilizing a similar or identical slant variation for the one or more first middle volume Bragg gratings (VBGs) 1902 and the one or more second middle volume Bragg gratings (VBGs) 1903.

In some examples, the input/output pair and/or the M1/M2 pair may have some design differences as well. For example, in some examples, the one or more input volume Bragg gratings (VBGs) 1901 and the one or more output volume Bragg gratings (VBGs) 1904 may have design differences related to exposure (i.e., intensity), distribution and spatial variation. So, in some examples, the one or more input volume Bragg gratings (VBGs) 1901 may implement a uniform intensity, while the one or more output volume Bragg gratings (VBGs) 1904 may implement a varying intensity (e.g., from low to high). Also, in some examples, a “strength” of the one or more input volume Bragg gratings (VBGs) 1901 (e.g., a lower delta n) may vary from a “strength” of the one or more output volume Bragg gratings 1904 (e.g., a higher delta n). Also, in some examples, a delta n (i.e., spatial distribution or spatial multiplexing) or a diffraction efficiency may be implemented to be different between the one or more input volume Bragg gratings (VBGs) and the one or more output volume Bragg gratings (VBGs) as well. It may be appreciated that, in some examples, these design differences may be implemented with respect the M1/M2 pair as well.

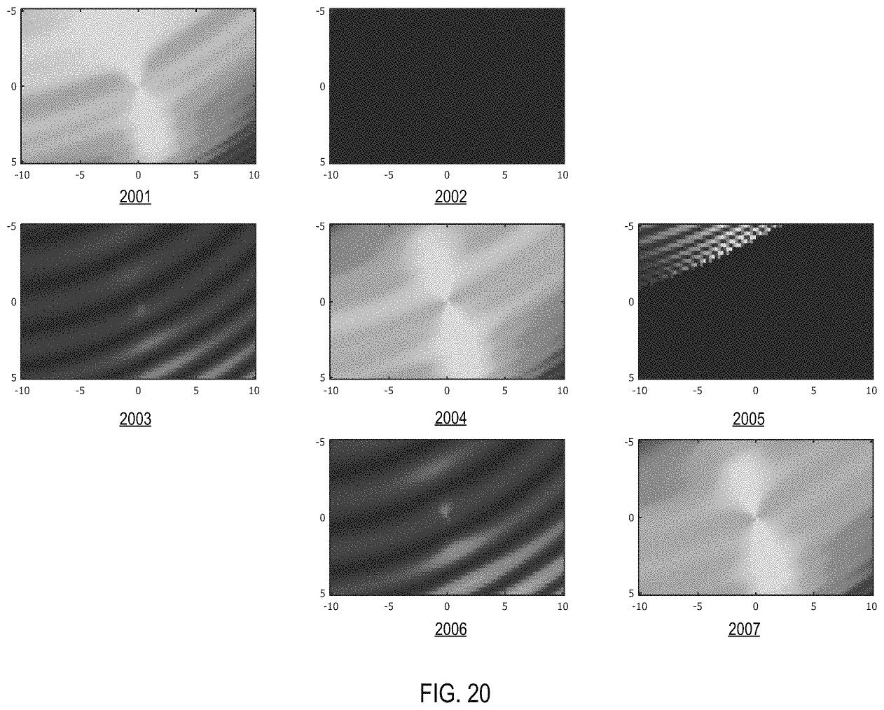

FIG. 20 illustrates various graphical representations 2001-2007 associated with one or more input volume Bragg gratings (VBGs) of a waveguide configuration in association with a two-dimensional (2D) expander. In some examples, the one or more input volume Bragg gratings (VBGs) may include one or more volume Bragg gratings (VBGs) for blue, one or more volume Bragg gratings (VBGs) for green, and one or more volume Bragg gratings (VBGs) for red. Also, in some examples, the one or more input volume Bragg gratings (VBGs) may share design aspects with one or more output volume Bragg gratings (VBGs), as discussed above.

In some examples, the graphical representations 2001-2007 may illustrate various diffraction intensities over a two-dimensional field of view (FOV) for the one or more input volume Bragg gratings (VBGs). In these examples, graphical representation 2001 may pertain to one or more input volume Bragg gratings (VBGs) for blue, graphical representation 2004 may pertain to one or more input volume Bragg gratings (VBGs) for green, and graphical representation 2007 may pertain to one or more volume Bragg gratings (VBGs) for red. In some instances, the graphical representations 2001, 2004, and 2007 may illustrate efficiencies in an “designed” color band. In addition, graphical representations 2002, 2003, 2005 and 2006 may indicate crosstalk that may result from interaction between the sets of gratings. In some instances, the graphical representations 2002, 2003, 2005 and 2006 may be referred to as “spill-over” or “unwanted” color band, and may illustrate spill-over color band crosstalk.

In some examples, aspects of one or more volume Bragg gratings (VBGs) of a waveguide configuration in association with a two-dimensional (2D) expander may be optimized to, among other things, increase diffraction efficiencies and minimize crosstalk. In some examples, optimization of the one or more volume Bragg gratings (VBGs) of a waveguide configuration in association with a two-dimensional (2D) expander may include maximizing a minimum efficiency (i.e., maximize a smallest diffraction efficiency associated with a minimum signal) for each one or more volume Bragg gratings (VBGs) associated with a designed color band (e.g., blue, green, red). In addition, optimization of the one or more volume Bragg gratings (VBGs) of a waveguide configuration in association with a two-dimensional (2D) expander may also include minimizing a maximum efficiency for each one or more volume Bragg gratings (VBGs) associated with an unwanted color band.

In some examples (and as discussed above), the (optimized) design parameters of one or more input volume Bragg gratings (VBGs) may be shared by one or more output volume Bragg gratings (VBGs). Also, in some examples, one or more input volume Bragg gratings (VBGs) associated with blue, the one or more input volume Bragg gratings (VBGs) associated with green, and the input one or more volume Bragg gratings (VBGs) associated with red may share a same pitch and a same slant variation as one or more output volume Bragg gratings (VBGs) associated with blue, the one or more output volume Bragg gratings (VBGs) associated with green, and the output one or more volume Bragg gratings (VBGs) associated with red.

In some examples, one or more parameters associated with the one or more volume Bragg gratings (VBGs) (e.g., an input/output pair) of a waveguide configuration in association with a two-dimensional (2D) expander may be optimized. In some examples, a first parameter to be optimized may be a pitch (i.e., period) exhibited along a surface of the one or more volume Bragg gratings (VBGs). In some examples, a second parameter may be a range of slant variation associated with the one or more volume Bragg gratings (VBGs). Furthermore, in some examples, a third parameter may be properties associated with crosstalk.

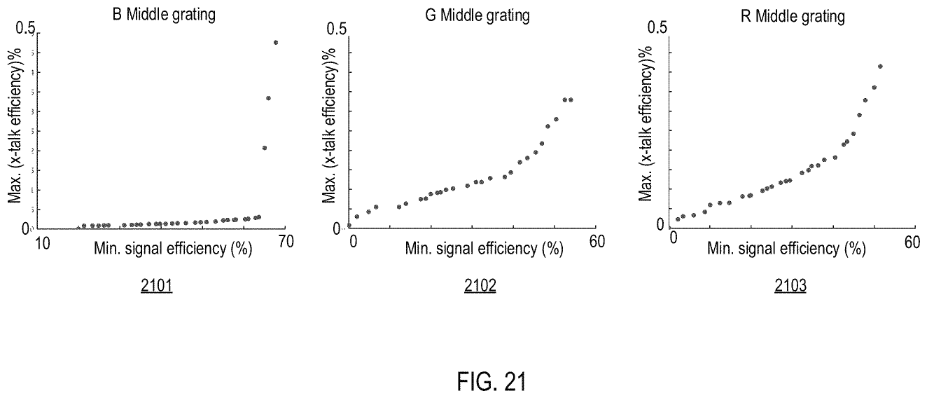

FIG. 21 illustrates various graphical representations 2101-2103 of results associated with component level optimization(s) of one or more input volume Bragg gratings (VBGs) of a waveguide configuration in association with a two-dimensional (2D) expander. In particular, graphical representation 2101 illustrates results associated with optimization of one or more volume Bragg gratings (VBGs) associated with blue, graphical representation 2102 illustrates results associated with optimization of one or more volume Bragg gratings (VBGs) associated with green, and graphical representation 2103 illustrates results associated with optimization of one or more volume Bragg gratings (VBGs) associated with red.

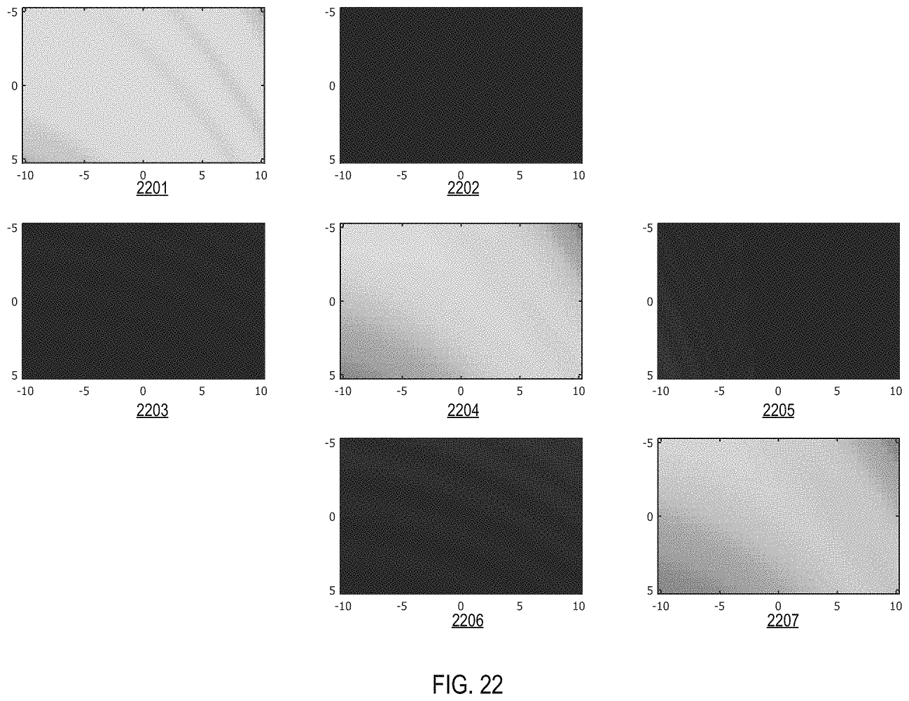

FIG. 22 illustrates various graphical representations 2201-2207 associated with one or more input (or output) volume Bragg gratings (VBGs) of a waveguide configuration in association with a two-dimensional (2D) expander. In the graphical representations 2201-2207 may indicate efficiencies associated with a “designed” color band (i.e., graphical representations 2201, 2204, and 2207) and an “unwanted” color band (i.e., graphical representations 2202, 2203, 2205 and 2206) for the one or more input volume Bragg gratings (VBGs). In some examples, the parameters of the one or more input volume Bragg gratings (VBGs) and the one or more output volume Bragg gratings (VBGs) may be optimized to increase efficiencies associated with the designed color band, and decrease inefficiencies (e.g., crosstalk) associated with the unwanted color band. In some examples where one or more output volume Bragg gratings (VBGs) may share a similar design to the one or more input volume Bragg gratings (VBGs), the efficiencies exhibited by the one or more output volume Bragg gratings (VBGs) may be similar to those in the graphical representations 2201-2207.

As illustrated in the graphical representations 2201, 2204, and 2207, efficiencies in an “designed” color band may be nearly fully or fully optimized. Moreover, as illustrated in the graphical representations 2201, 2204, and 2207, efficiencies in an “designed” color band may be nearly fully or fully optimized. Moreover, the graphical representations 2202, 2203, 2205 and 2206 illustrating efficiencies in the “spill-over” or “unwanted” color band may indicate near or full elimination of crosstalk.

Furthermore, in some examples, one or more parameters associated with the one or more middle (i.e., M1/M2) volume Bragg gratings (VBGs) of a waveguide configuration in association with a two-dimensional (2D) expander may be optimized as well. In some examples, for an M1/M2 pair, one or more volume Bragg gratings (VBGs) associated with blue, one or more volume Bragg gratings (VBGs) associated with green, and one or more volume Bragg gratings (VBGs) associated with M1/M2 gratings pair may be optimized.

As discussed above, in some examples, the (optimized) design parameters of the one or more first middle (i.e., M1) volume Bragg gratings (VBGs) may be shared by one or more second middle (i.e., M2) volume Bragg gratings (VBGs). In some examples, one or more first middle volume Bragg gratings (VBGs) associated with blue, the one or more first middle volume Bragg gratings (VBGs) associated with green, and the first middle one or more volume Bragg gratings (VBGs) associated with red may share a same pitch along a volume Bragg (VBG) surface and a same slant variation as one or more second middle volume Bragg gratings (VBGs) associated with blue, the one or more second middle volume Bragg gratings (VBGs) associated with green, and the second middle one or more volume Bragg gratings (VBGs) associated with red.

In addition, it should be appreciated that, in some examples, a first middle one or more volume Bragg gratings (VBGs) may have a different intensity, diffraction efficiencies and/or delta n (i.e., spatial variation or spatial multiplexing) than a second middle one or more volume Bragg gratings (VBGs). Furthermore, in some examples, a first parameter to be optimized may be a pitch (i.e., period) exhibited along a surface of the M1/M2 pair, a second parameter may be a range of slant variation associated with the M1/M2 pair, and a third parameter may be properties of the M1/M2 pair associated with crosstalk.

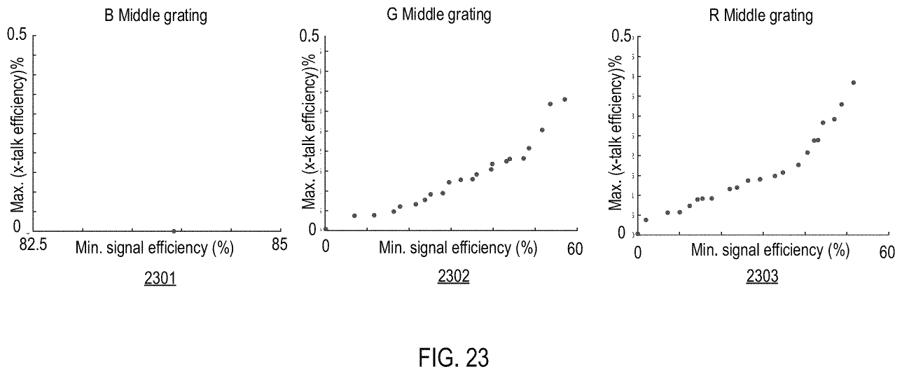

FIG. 23 illustrates various graphical representations 2301-2303 of results associated with component level optimization of one or more middle (i.e., M1/M2) volume Bragg gratings (VBGs) of a waveguide configuration in association with a two-dimensional (2D) expander. In particular, graphical representation 2301 illustrates results associated with optimization of one or more volume Bragg gratings (VBGs) associated with blue, graphical representation 2302 illustrates results associated with optimization of one or more volume Bragg gratings (VBGs) associated with green, and graphical representation 2303 illustrates results associated with optimization of one or more volume Bragg gratings (VBGs) associated with red.

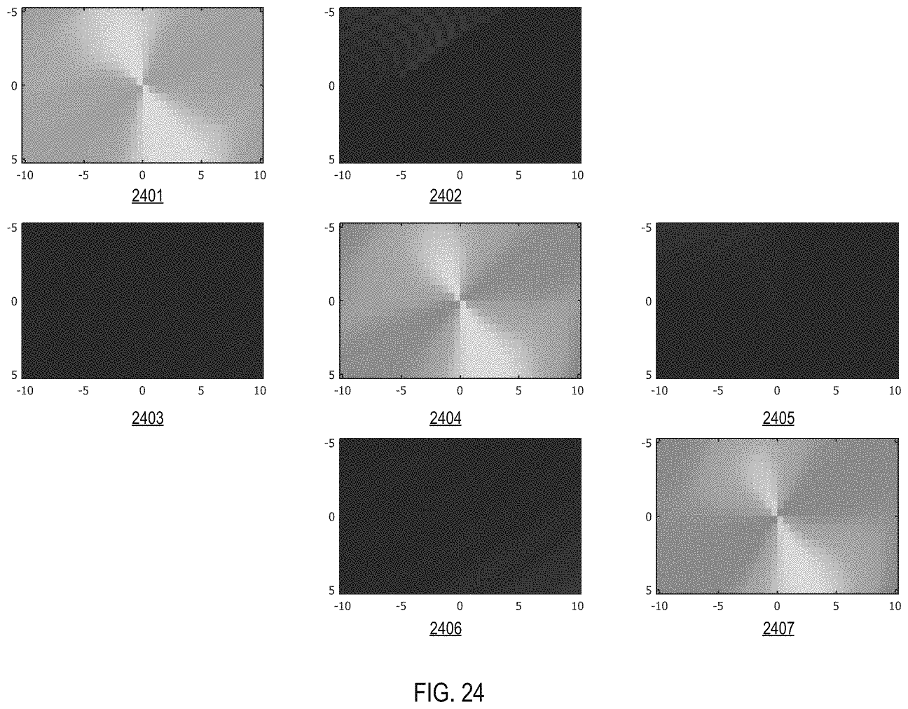

FIG. 24 illustrates various graphical representations 2401-2407 associated with one or more middle (i.e., M1/M2) volume Bragg gratings (VBGs) of a waveguide configuration in association with a two-dimensional (2D) expander. In some examples, the parameters of the one or more one or more M1 volume Bragg gratings (VBGs) and the one or more M2 volume Bragg gratings (VBGs) may be optimized to increase efficiencies associated with the designed color band, and to decrease inefficiencies (e.g., crosstalk) associated with the unwanted color band. As illustrated in the graphical representations 2401, 2404, and 2407, efficiencies in an “designed” color band may be nearly fully or fully optimized. Moreover, as illustrated in the graphical representations 2401, 2404, and 2407, efficiencies in an “designed” color band may be nearly fully or fully optimized. Moreover, the graphical representations 2402, 2403, 2405 and 2406 illustrating efficiencies in the “spill-over” or “unwanted” color band may indicate near or full elimination of crosstalk.

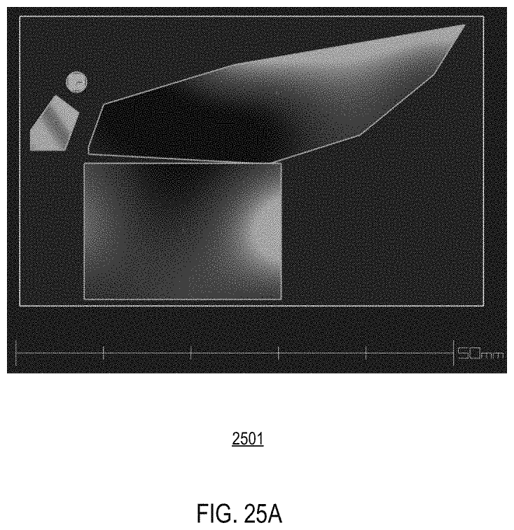

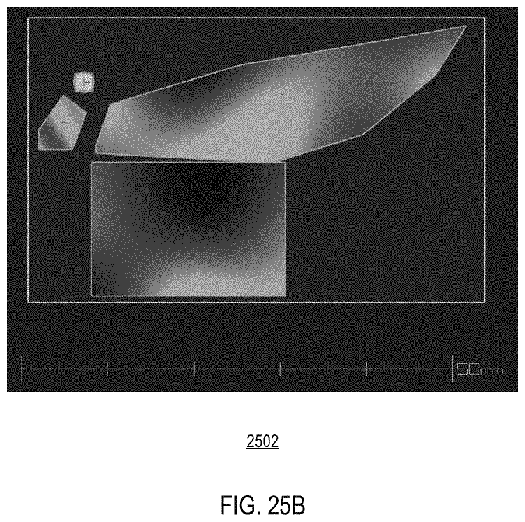

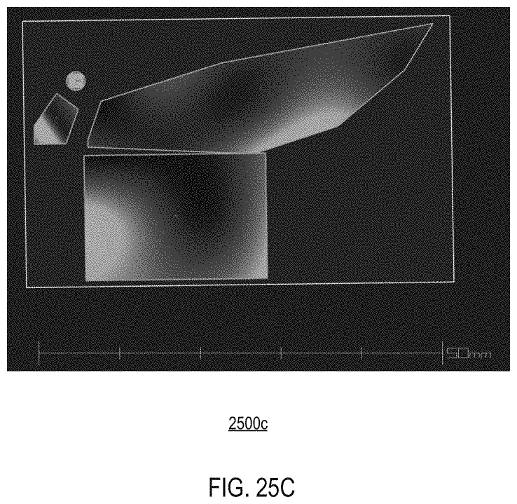

Based on the optimizations described above, in some examples, one or more design parameters associated with one or more volume Bragg gratings (VBGs) in a waveguide configuration for a two-dimensional (2D) expander may be determined. It may be appreciated that while these one or more design parameters may be primarily associated with a variant slant design for reflection-type volume Bragg gratings (VBGs), these concepts may be associated with transmission-type volume Bragg gratings (VBGs) as well. In some examples, a particular delta n ((i.e., spatial variation or spatial multiplexing) and a volume Bragg grating (VBG) thickness of 10 micrometers (μm) may be utilized. FIGS. 25A-C illustrate various diagrams of delta n (i.e., spatial variation or spatial multiplexing) distributions that may be implemented with regard to one or more volume Bragg gratings (VBGs) associated with a color, according to examples. FIG. 25A illustrates an example of a delta n distribution 2501 in association with blue, FIG. 25B illustrates an example of a delta n distribution 2502 in association with green, and FIG. 25C illustrates an example of a delta n distribution 2503 in association with red. It may be appreciated that each of one or more (optimized) input and one or more (optimized) output volume Bragg gratings (VBGs), and one or more (optimized) first middle volume Bragg gratings (VBGs) and one or more second middle volume Bragg gratings (VBGs) may be implemented in a two-dimensional (2D) expander to expand a field of view (FOV) for a display system.

For one or more input or output volume Bragg gratings (VBGs) associated with blue, a pitch along a volume Bragg grating (VBG) surface may be approximately between 0.30-0.35 micrometers (μm), and a range of slant variation may be approximately between −63.7242 and −57.5650 degrees. For one or more middle (i.e., M1, M2) volume Bragg gratings (VBGs) associated with blue, a pitch along a volume Bragg grating (VBG) surface may be approximately between 0.15-0.20 micrometers (μm), and a range of slant variation may be approximately between −39.7641 and −30.5147 degrees.

For one or more input or output volume Bragg gratings (VBGs) associated with green, a pitch along a volume Bragg grating (VBG) surface may be approximately between 0.40-0.45 micrometers (μm), and a range of slant variation may be approximately between −63.5513 and −57.1279 degrees. For one or more middle (i.e., M1, M2) volume Bragg gratings (VBGs) associated with green, a pitch along a volume Bragg grating (VBG) surface may be approximately between 0.20-0.25 micrometers (μm), and a range of slant variation may be approximately between −31.4096 and −40.2968 degrees.

For one or more input or output volume Bragg gratings (VBGs) associated with red, a pitch along a volume Bragg grating (VBG) surface may be approximately between 0.45-0.50 micrometers (μm), and a range of slant variation may be approximately between −64.0559 and −57.7185 degrees. For one or more middle (i.e., M1, M2) volume Bragg gratings (VBGs) associated with red, a pitch along a volume Bragg grating (VBG) surface may be approximately between 0.25-0.30 micrometers (μm), and a range of slant variation may be approximately between −31.2050 and −40.2315 degrees.

Upon optimization of design aspects (e.g., range of slant variation, pitch, grating thickness, etc.) of one or more volume Bragg gratings (VBGs) of a waveguide configuration for a two-dimensional (2D) expander for a display system on a component level (as discussed above), one or more additional aspects of the two-dimensional (2D) expander (e.g., on a “system level”) may be optimized as well. In some examples, this may include optimization of an aspects associated with input (i.e., or “in-coupling”) efficiencies and aspects associated with output (i.e. “out-coupling”) efficiencies.

In some examples, a first optimization may be implemented with respect to input efficiencies. More specifically, in some examples, aspects of a two-dimensional (2D) expander may be optimized for how much light may be coupled to one or more volume Bragg gratings (VBGs) of the two-dimensional (2D) expander (i.e., how much light is to be input). In some examples, this may include optimizing for efficiency across an entire field of view (FOV) with respect to three colors (e.g., blue, green, red) of the color band.

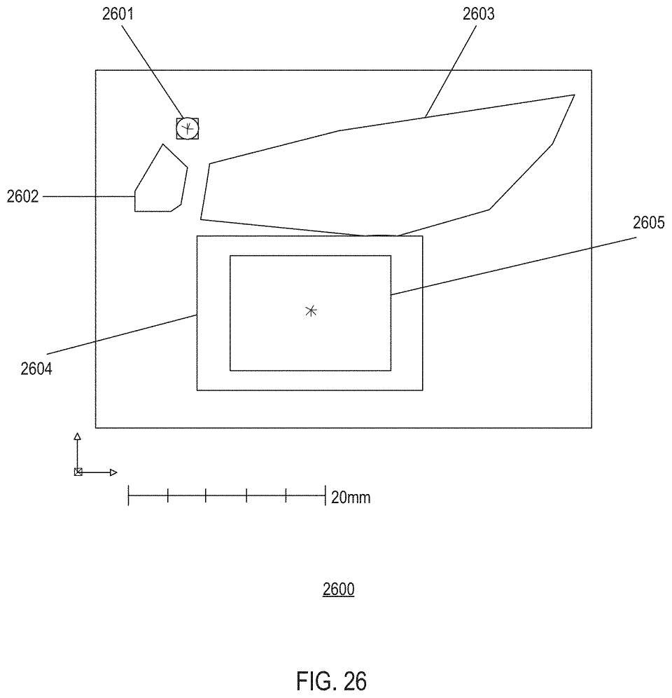

FIG. 26 illustrates a diagram of a waveguide configuration 2600 including one or more volume Bragg gratings (VBGs) associated with a two-dimensional (2D) expander, according to an example. In some examples, the waveguide configuration 2600 may enable light from a projector (not shown) to be directed to one or more input volume Bragg gratings (VBGs) 2601, and then propagated to one or more first middle (M1) volume Bragg gratings (VBGs) 2602 and one or more second middle (M2) volume Bragg gratings (VBGs) 2603, and further output to one or more output volume Bragg gratings (VBGs) 2604 towards an eyebox 2605. In some examples, the eyebox may be fifteen to twenty (15-20) millimeters (mm) in height, and ten to fifteen millimeters (mm) in width. In particular, in some examples, the eyebox may be sixteen (16) millimeters (mm) in height, and twelve (12) millimeters (mm) in width. In some examples, an area of a user's pupil (e.g., 3 millimeters) may linearly extend to within an area of the eyebox.

In some examples, to provide input efficiency optimization may include maximizing a mean input (i.e., in-coupling) efficiency across a field of view (FOV). In addition, in some examples, providing input efficiency may also include maximizing a minimum of overall input efficiencies across a field of view (FOV). In some examples, these aspects may be provided with respect to three colors (e.g., blue, green, red) of the color band. In some examples, providing input efficiency optimization may also include optimization of the one or more input volume Bragg gratings (VBGs) 2601 and the one or more first middle (M1) volume Bragg gratings (VBGs) 2602.

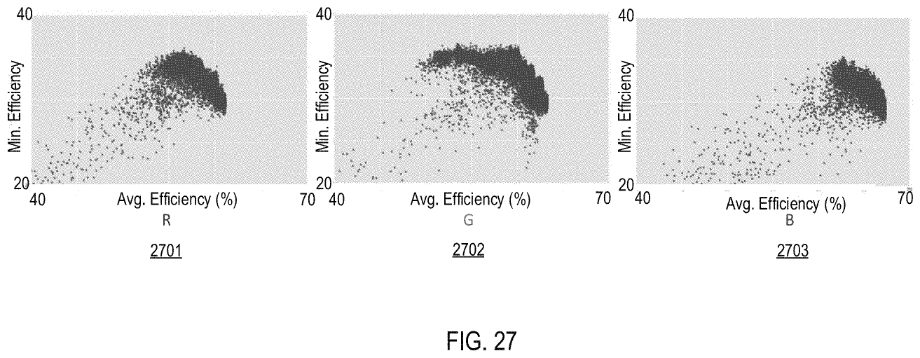

FIG. 27 illustrates various graphical representations 2701-2703 associated with one or more volume Bragg gratings (VBGs) of a waveguide configuration utilized in a two-dimensional (2D) expander. In some examples, these graphical representations 2701-2703 may indicate an average efficiency (i.e., x-axis) and a minimum efficiency (i.e., y-axis) across a field of view (FOV). Also, in these graphical representations 2701-2703, each point illustrated may correspond to one or more volume Bragg gratings (VBGs) having a particular range of slant variation and a particular pitch. In some examples, based on the graphical representations 2701-2703, a design with an optimal efficiency (i.e., a Pareto optimal) associated with particular delta n (i.e., spatial distribution or spatial multiplexing) for a particular range of slant variation and a particular pitch may be selected for each color (i.e., red, blue, green) in the color band. In some examples, this particular delta n may be implemented for the one or more input volume Bragg gratings (VBGs) and the one or more first middle volume Bragg gratings (VBGs). In some examples, graphical representation 2701 may relate to one or more volume Bragg gratings (VBGs) for red, graphical representation 2702 may relate to one or more volume Bragg gratings (VBGs) for green, and graphical representation 2703 may relate to one or more volume Bragg gratings (VBGs) for blue.

In some examples, a second optimization may be implemented with respect to output efficiencies. More specifically, in some examples, aspects of a two-dimensional (2D) expander may be optimized for how much light may be distributed to an eyebox of the display system. In some examples, this may include optimizing for efficiency across an entire field of view (FOV) with respect to three colors (e.g., blue, green, red) of the color band.

In some examples, to provide output efficiency optimization may include maximizing a mean output (i.e., eyebox) efficiency across entire field of view (FOV). In addition, in some examples, providing output efficiency may also include minimizing pupil uniformity across entire field of view (FOV). In some examples, these aspects may be provided with respect to three colors (e.g., blue, green, red) of the color band. In some examples, providing output efficiency optimization may also include optimization of one or more second middle (M2) volume Bragg gratings (VBGs) (e.g., the volume Bragg gratings (VBGs) 2503 and one or more output volume Bragg gratings (VBGs) (e.g., the volume Bragg gratings (VBGs) 2504).

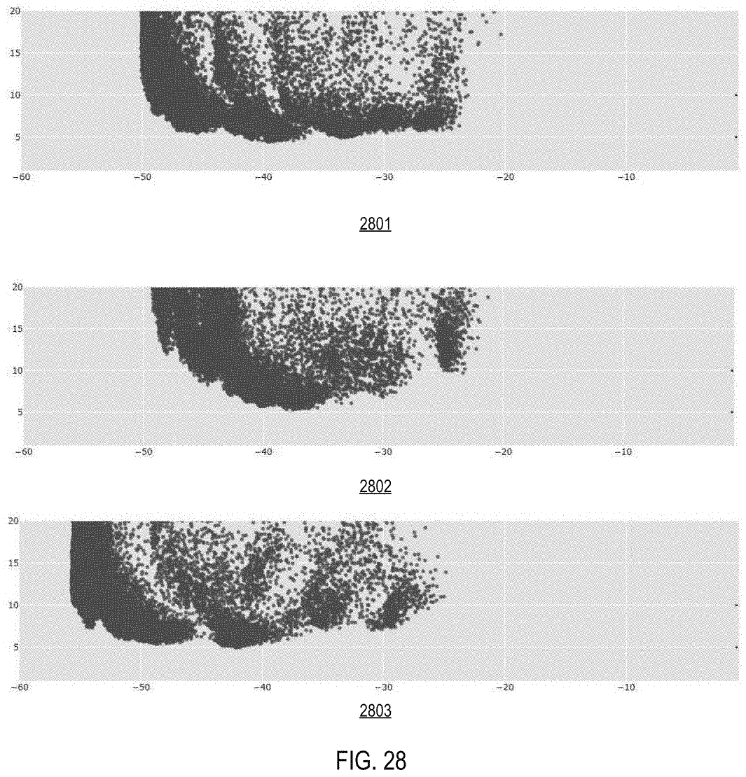

FIG. 28 illustrates various graphical representations 2801-2803 associated with one or more volume Bragg gratings (VBGs) of a waveguide configuration utilized in a two-dimensional (2D) expander. In these graphical representations 2801-2803, the x-axis may indicate an eyebox efficiency across an entire supported field of view (FOV), where a higher value may value may indicate greater efficiency. Furthermore, in these graphical representations 2801-2803, the y-axis may indicate a pupil uniformity across an entire supported field of view (FOV), which may capture in variation (i.e., maximum to minimum) in intensity across a field of view (FOV) for particular pupil location. In some examples, minimization of this variation may be desirable, and accordingly a smaller value may be desirable. Also, in these graphical representations 2801-2803, each point illustrated may correspond to one or more volume Bragg gratings (VBGs) having a particular range of slant variation and a particular pitch along a volume Bragg grating (VBG) surface. Also, in these graphical representations 2801-2803, each point illustrated may correspond to one or more volume Bragg gratings (VBGs) having a particular range of slant variation and a particular pitch. In some examples, based on the graphical representations 2801-2803, a design with an optimal efficiency (i.e., a Pareto optimal) associated with particular delta n (i.e., spatial distribution or spatial multiplexing) for a particular range of slant variation and a particular pitch may be selected for each color (i.e., red, blue, green) in the color band. In particular, in some examples, a plurality of pupil locations associated with an area of the eyebox may be sampled and/or optimized to minimize for pupil uniformity. In some examples, this particular delta n may be implemented for the one or more second middle volume Bragg gratings (VBGs) and the one or more output volume Bragg gratings (VBGs). In some examples, graphical representation 2801 may relate to one or more volume Bragg gratings (VBGs) for red, graphical representation 2802 may relate to one or more volume Bragg gratings (VBGs) for green, and graphical representation 2803 may relate to one or more volume Bragg gratings (VBGs) for blue.

It should be appreciated that, in some examples, combining design parameters from a first, input optimization and second, output optimization may provide a “full system” optimization for a two-dimensional (2D) expander for use in a display system. In particular, in some examples, one or more input volume Bragg gratings (VBGs) and one or more first middle volume Bragg gratings (VBGs) from a first, input optimization may be combined with one or more second middle volume Bragg gratings (VBGs) and one or more output volume Bragg gratings (VBGs) to provide the “full system” optimization for the two-dimensional (2D) expander. In some examples, upon implementation of a full system optimization as described herein, an increase of thirty percent (30%) in eyebox efficiency may be achieved. Moreover, in some examples, upon implementation of a full system optimization as described herein, a pupil efficiency of three percent (3%) across an entire color band may be achieved as well. Also, in some examples, implementation of a full-system optimization may mitigate a trade-off that may come with attempting to minimize a “ghosting” effect induced by crosstalk associated with one or more gratings of a waveguide and attempting to minimize artifacts that may appear in a field of view (FOV).

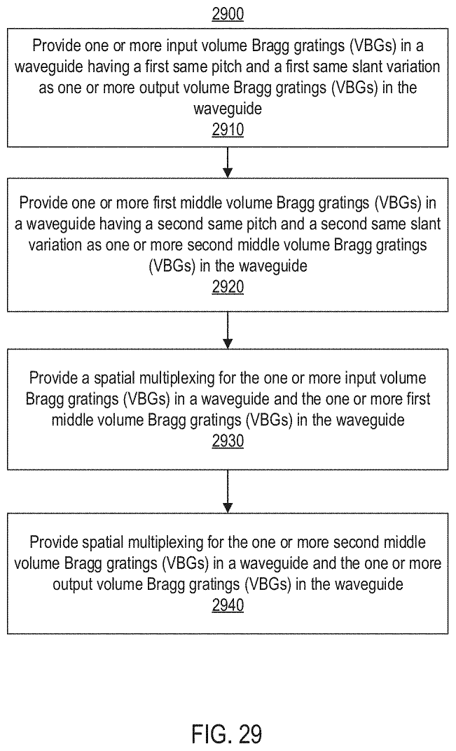

FIG. 29 illustrates a method for manufacturing a two-dimensional (2D) expander for a display system having a wearable eyewear arrangement, according to an example. The method 2900 is provided by way of example, as there may be a variety of ways to carry out the method described herein. Each block shown in FIG. 29 may further represent one or more processes, methods, or subroutines, and one or more of the blocks may include machine-readable instructions stored on a non-transitory computer-readable medium and executed by a processor or other type of processing circuit to perform one or more operations described herein.

Reference is now made with respect to FIG. 29. At 2910, one or more input volume Bragg gratings (VBGs) in a waveguide having a first same pitch and a first same slant variation as one or more output volume Bragg gratings (VBGs) in the waveguide may be provided.

At 2920, one or more first middle volume Bragg gratings (VBGs) in the waveguide having a second same pitch and a second same slant variation as one or more second middle volume Bragg gratings (VBGs) in the waveguide may be provided.

At 2930, a spatial multiplexing for the one or more input volume Bragg gratings (VBGs) in the waveguide and the one or more first middle volume Bragg gratings (VBGs) in the waveguide may be provided. In some examples, the spatial multiplexing is selected based on at least one of maximizing a smallest diffraction efficiency associated with a minimum signal associated with the waveguide and minimizing a maximum efficiency associated with the waveguide.

At 2940, spatial multiplexing for the one or more second middle volume Bragg gratings (VBGs) in the waveguide and the one or more output volume Bragg gratings (VBGs) in the waveguide is provided. In some examples, the spatial multiplexing is selected based on at least one of maximizing a mean output efficiency across a field of view (FOV) associated with the waveguide and minimizing a maximum of overall output efficiencies associated with pupil uniformity across a field of view (FOV) associated with the waveguide.

In the following description, various inventive examples are described, including devices, systems, methods, and the like. For the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples.

The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example’ is not necessarily to be construed as preferred or advantageous over other embodiments or designs.

Although the methods and systems as described herein may be directed mainly to digital content, such as videos or interactive media, it should be appreciated that the methods and systems as described herein may be used for other types of content or scenarios as well. Other applications or uses of the methods and systems as described herein may also include social networking, marketing, content-based recommendation engines, and/or other types of knowledge or data-driven systems.

1. A display system, comprising:
a first lens assembly comprising:
a first projector to propagate first display light associated with a first image; and
a first two-dimensional (2D) expander including a first waveguide including one or more first gratings having a variant slant design for propagating the first display light to a first eye of a user.

2. The display system of claim 1, further comprising:
a second lens assembly comprising:
a second projector to propagate second display light associated with a second image; and
a second two-dimensional (2D) expander including a second waveguide having one or more second gratings having a variant slant design for propagating the second display light to a second eye of a user.

3. The display system of claim 1, wherein the first waveguide is comprised of a substrate and a photopolymer layer, and wherein the photopolymer layer comprises the one or more first gratings having the variant slant design.

4. The display system of claim 1, wherein the one or more first gratings having the variant slant design are volume Bragg gratings (VBGs).

5. The display system of claim 1, wherein the one or more first gratings having the variant slant design implement an adiabatic slant variation.

6. The display system of claim 1, wherein the one or more gratings having the variant slant design comprise one or more input volume Bragg gratings (VBGs), one or more first middle volume Bragg gratings (VBGs), one or more second middle volume Bragg gratings (VBGs) and one or more output volume Bragg gratings (VBGs).

7. The display system of claim 6, wherein the one or more input volume Bragg gratings (VBGs) and the one or more output volume Bragg gratings (VBGs) implement a same pitch and a same slant variation.

8. The display system of claim 6, wherein a spatial multiplexing for the one or more input volume Bragg gratings (VBGs) and the one or more first middle volume Bragg gratings (VBGs) is selected based on at least one of:
maximizing a smallest diffraction efficiency associated with a minimum signal associated with the first waveguide; and
minimizing a maximum efficiency associated with the first waveguide.

9. The display system of claim 6, wherein the one or more first middle volume Bragg gratings (VBGs) and the one or more second middle volume Bragg gratings (VBGs) implement a same pitch and a same slant variation.

10. The display system of claim 6, wherein a spatial multiplexing for the one or more second middle volume Bragg gratings (VBGs) and the one or more output volume Bragg gratings (VBGs) is selected based on at least one of:
maximizing a mean output efficiency across a field of view (FOV) for the first lens assembly; and
minimizing a maximum of overall output efficiencies associated with pupil uniformity across a field of view (FOV) for the first lens assembly.

11. The display system of claim 5, wherein the one or more first gratings having the variant slant design comprise a set of one or more input volume Bragg gratings (VBGs), a set of one or more first middle volume Bragg gratings (VBGs), a set of one or more second middle volume Bragg gratings (VBGs) and a set of one or more output volume Bragg gratings (VBGs) for each color blue, green, and red.

12. The display system of claim 5, wherein the first waveguide and the second waveguide have a thickness of approximately 500 micrometers (μm).

13. An apparatus, comprising:
a projector to propagate display light associated with an image; and
a two-dimensional (2D) expander for propagating the display light to an eye of a user, the two-dimensional (2D) expander including a waveguide having one or more volume Bragg gratings (VBGs) with a variant slant design.

14. The apparatus of claim 13, wherein the variant slant design comprises at least one of an adiabatic slant design or a multi-layer lamination design.

15. The apparatus of claim 14, wherein the multi-layer lamination design comprises one or more buffer layers in between a plurality of grating layers.

16. The apparatus of claim 13, wherein the one or more volume Bragg gratings (VBGs) comprises a first set of volume Bragg gratings (VBGs) for blue having a first slant variation, a second set of volume Bragg gratings (VBGs) for green having a second slant variation, and a third set of volume Bragg gratings (VBGs) for red having a third slant variation.

17. The apparatus of claim 16, wherein the one or more volume Bragg gratings (VBGs) comprises a volume Bragg grating (VBG) having an approximately 10 micrometer (μm) thickness.

18. A method for manufacturing a two-dimensional (2D) expander for a display system, comprising:
providing one or more input volume Bragg gratings (VBGs) in a waveguide having a first same pitch and a first same slant variation as one or more output volume Bragg gratings (VBGs) in the waveguide;
providing one or more first middle volume Bragg gratings (VBGs) in the waveguide having a second same pitch and a second same slant variation as one or more second middle volume Bragg gratings (VBGs) in the waveguide;
providing a first spatial multiplexing for the one or more input volume Bragg gratings (VBGs) in the waveguide and the one or more first middle volume Bragg gratings (VBGs) in the waveguide; and
providing a second spatial multiplexing for the one or more second middle volume Bragg gratings (VBGs) in the waveguide and the one or more output volume Bragg gratings (VBGs) in the waveguide.

19. The method of claim 18, wherein the first spatial multiplexing is selected based on at least one of:
maximizing a smallest diffraction efficiency associated with a minimum signal associated with the waveguide; and
minimizing a maximum efficiency associated with the first waveguide.

20. The method of claim 18, wherein the second spatial multiplexing is selected based on at least one of:
maximizing a mean output efficiency across a field of view (FOV) associated with the waveguide; and
minimizing a maximum of overall output efficiencies associated with pupil uniformity across a field of view (FOV) associated with the waveguide.
